(19) United States
(12) Patent Application Publication
(10) Pub. No.: US 2021/0117828 A1
(43) Pub. Date: Apr. 22, 2021

(54) INFORMATION PROCESSING APPARATUS, INFORMATION PROCESSING METHOD, AND PROGRAM

(71) Applicant: SONY CORPORATION, TOKYO (JP)

(72) Inventors: SHINGO TAKAMATSU, TOKYO (JP); KENTO NAKADA, TOKYO (JP); YUJI HORIGUCHI, TOKYO (JP); HIROSHI IIDA, TOKYO (JP); MASANORI MIYAHARA, TOKYO (JP)

(21) Appl. No.: 17/253,005

(22) PCT Filed: Jun. 13, 2019
(86) PCT No.: PCT/JP2019/023410

§ 371 Date: Dec. 16, 2020

(30) Foreign Application Priority Data
Jun. 27, 2018 (JP) 2018-121577
Jan. 24, 2019 (JP) 2019-010269

(51) Int. Cl. G06N 5/04; G06N 20/00; G06F 16/22; G06F 16/28

(52) U.S. Cl. CPC G06N 5/04; G06F 16/285; G06F 16/2282; G06N 20/00

(57) ABSTRACT

The present disclosure relates to an information processing apparatus, an information processing method, and a program that allow improvement of a learning data set to be facilitated. A prediction analysis section calculates an evaluation value for an evaluation data set used to evaluate a prediction model, for a predetermined number of data samples in a learning data set used for training of the prediction model, and on the basis of the evaluation value for all the data samples in the learning data set and gradients of the data samples, an advice generation section generates presentation information for presenting advice related to at least one of the data samples in the learning data set or feature amounts of the data samples. A technique according to the present disclosure can be applied to prediction of a contract price of a previously used condominium, for example.

### TECHNICAL FIELD

The present disclosure relates to an information processing apparatus, an information processing method, and a program, and in particular to an information processing apparatus, an information processing method, and a program that allow improvement of a learning data set to be facilitated.

### BACKGROUND ART

A technique that is referred to as prediction analysis and in which future results are predicted on the basis of past data is known.

For example, PTL 1 discloses a technique for predicting a contract probability for a real estate transaction that is used as a reference for determination of a sale/lending price of a real estate and for adjustment of a contract price.

### CITATION LIST

### Patent Literature

### [PTL 1]

Japanese Patent Laid-open No. 2017-16321

### SUMMARY

### Technical Problem

The prediction accuracy of prediction analysis is determined mainly by the following three factors.

1. Prediction model used for prediction

2. Quantity and quality of a learning data set used to construct the prediction model

3. Difficulty in an original prediction target

Many known techniques improve the prediction model in 1. to increase the prediction accuracy. For 3., technical measures have been difficult to take, for example, when a coin is tossed, whether heads or tails come up fails to be accurately predicted.

On the other hand, improvement of the learning data set in 2. requires domain knowledge of a target prediction problem and expertise of prediction analysis, and thus improving the learning data set to increase the prediction accuracy has also been very difficult.

In view of these circumstances, an object of the present disclosure is to allow improvement of the learning data set to be facilitated.

### Solution to Problem

An information processing apparatus of the present disclosure includes a prediction analysis section that calculates an evaluation value for an evaluation data set used to evaluate a prediction model, for a predetermined number of data samples in a learning data set used for training of the prediction model; and an advice generation section that generates, on the basis of the evaluation value for all the data samples in the learning data set and gradients of the data samples, presentation information for presenting advice related to at least one of the data samples in the learning data set or feature amounts of the data samples.

An information processing method of the present disclosure includes calculating, by an information processing apparatus, an evaluation value for an evaluation data set used to evaluate a prediction model, for a predetermined number of data samples in a learning data set used for training of the prediction model, and by the information processing apparatus, on the basis of the evaluation value for all the data samples in the learning data set and gradients of the data samples, generating presentation information for presenting advice related to at least one of the data samples in the learning data set or feature amounts of the data samples.

A program of the present disclosure causes a computer to execute processing of calculating an evaluation value for an evaluation data set used to evaluate a prediction model, for a predetermined number of data samples in a learning data set used for training of the prediction model, and on the basis of the evaluation value for all the data samples in the learning data set and gradients of the data samples, generating presentation information for presenting advice related to at least one of the data samples in the learning data set or feature amounts of the data samples.

According to the present disclosure, the evaluation value for the evaluation data set used to evaluate the prediction model is calculated for the predetermined number of data samples in the learning data set used for training of the prediction model, and on the basis of the evaluation value for all the data samples in the learning data set and gradients of the data samples, the presentation information for presenting the advice related to at least one of the data samples in the learning data set or feature amounts of the data samples is generated.

### Advantageous Effect of Invention

According to the present disclosure, improvement of the learning data set can be facilitated.

Note that the effect described here is not necessarily limited and that any of the effects described in the present disclosure may be produced.

### BRIEF DESCRIPTION OF DRAWINGS

FIG. 1 is a diagram illustrating an example of tabular data.

FIG. 2 is a block diagram illustrating a functional configuration example of an information processing apparatus according to the present disclosure.

FIG. 3 is a flowchart illustrating feature amount vector generation processing.

FIG. 4 is a flowchart illustrating evaluation value list generation processing.

FIG. 5 is a diagram illustrating a graph of an evaluation value list.

FIG. 6 is a flowchart illustrating advice generation processing for improvement of a learning data set.

FIG. 7 is a diagram illustrating an example of a graph of an evaluation value and advice.

FIG. 8 is a diagram illustrating an example of a graph of the evaluation value and advice.

FIG. 9 is a diagram illustrating an example of a graph of the evaluation value and advice.

FIG. 10 is a diagram illustrating an example of a graph of the evaluation value and advice.

FIG. 11 is a flowchart illustrating advice generation processing for feature amount addition.

FIG. 12 is a diagram illustrating training of an error prediction model.

FIG. 13 is a diagram illustrating calculation of the degree of contribution of a feature amount to an error.

FIG. 14 is a diagram illustrating an example of presentation of advice for addition of a feature amount.

FIG. 15 is a block diagram illustrating a functional configuration example of an information processing apparatus connected to a database.

FIG. 16 is a diagram illustrating an overview of a prediction analysis system.

FIG. 17 is a block diagram illustrating a functional configuration example of a handbook creation apparatus.

FIG. 18 is a flowchart illustrating analysis information generation processing.

FIG. 19 is a diagram illustrating an example of analysis information.

FIG. 20 is a flowchart illustrating analysis information registration processing.

FIG. 21 is a diagram illustrating an example of registered analysis information.

FIG. 22 is a diagram illustrating an example of input information input during analysis information registration.

FIG. 23 is a flowchart illustrating advice information presentation processing.

FIG. 24 is a diagram illustrating an example of advice.

FIG. 25 is a diagram illustrating calculation of similarity.

FIG. 26 is a diagram illustrating an example of an accuracy evaluation graph.

FIG. 27 is a diagram illustrating an example of the accuracy evaluation graph.

FIG. 28 is a diagram illustrating an example of presentation of advice information.

FIG. 29 is a diagram illustrating an example of presentation of the advice information.

FIG. 30 is a block diagram illustrating a hardware configuration example of a computer.

### DESCRIPTION OF EMBODIMENT

An embodiment of the present disclosure (hereinafter referred to as the embodiment) will be described below. Note that the description of the embodiment will be in the following order.

1. Related Art and Problems

2. Overview of Technique According to Present Disclosure and Configuration of Information Processing Apparatus

3. Processing by Prediction Analysis Section

4. Advice Generation Processing (for Improvement of Learning Data Set)

5. Advice Generation Processing (for Addition of Feature Amount)

6. Application Example

7. Configuration of Prediction Analysis System

8. Analysis Information Transmission Processing

9. Analysis Information Registration Processing

10. Handbook Presentation Processing

11. Hardware Configuration of Computer

### 1. Related Art and Problems

A technique that is referred to as prediction analysis and in which future results are predicted on the basis of past data is known.

For example, by applying prediction analysis to customer data, a company providing a flat rate service can predict a probability at which the service will be cancelled at the timing of the next contract renewal. By implementing a marketing strategy such as distribution of coupons to customers likely to cancel the service, the company can efficiently prevent cancellation of the service. In this example, it is undesirable to distribute coupons to customers who continue the contract without distribution of coupons.

The prediction analysis preferably has higher prediction accuracy, and in a case where the results of the prediction analysis are used for business, the prediction accuracy is linked directly to the effect of the business. In the above-described example, in a case where the probability of cancellation of the service fails to be accurately predicted, the strategy for customers who are likely to truly cancel the service more often fails to be implemented. At the same time, in more cases, coupons are distributed to customers who retain the contract even without distribution of coupons. As a result, the strategy as a whole is inefficient.

The prediction accuracy of the prediction analysis is determined mainly by the following three factors.

1. Prediction model used for prediction

2. Quantity and quality of a learning data set used to construct the prediction model

3. Difficulty in an original prediction target

Many known techniques improve the prediction model in 1. to increase the prediction accuracy. For 3., technical measures have been difficult to take, for example, when a coin is tossed, whether heads or tails come up fails to be accurately predicted.

In the present embodiment, the learning data set in 2. is improved in order to increase the prediction accuracy. However, improvement of the learning data set requires domain knowledge of a target prediction problem (in the above-described example, knowledge of the flat-rate service and customers, knowledge of the system of the company, and the like) and expertise of prediction analysis. Thus, improving the learning data set to increase the prediction accuracy has also been very difficult.

Thus, a configuration will be described below in which, for facilitation of improvement of the learning data set, advice for improving the learning data set is generated.

### 2. Overview of Technique According to Present Disclosure and Configuration of Information Processing Apparatus

### Overview of Technique According to Present Disclosure

In the technique according to the present disclosure, on the basis of a variation in prediction accuracy and the absolute value of the prediction accuracy in a case where the number of learning data is varied, advice is generated as to whether to give priority to addition of a feature amount or to increase of the number of data. Furthermore, a pattern in which prediction errors become more serious is identified and prediction cases included in the pattern are presented to support a user in conceiving addition of a feature amount leading to increased prediction accuracy.

First, as an example of the present embodiment, an advice generation function of an information processing apparatus performing prediction analysis will be described, the advice generation function being used to improve a data set.

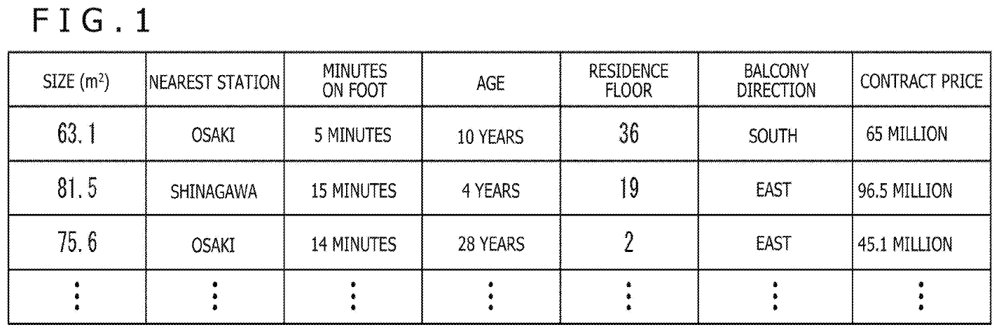

Input data in the prediction analysis is tabular data. FIG. 1 illustrates an example of tabular data.

The tabular data includes rows and columns. The rows correspond to data samples, and the columns correspond to items representing the attributes of data samples. The first row of the tabular data describes the names of the columns (items), and the second and subsequent rows describe, as the contents of the data samples, attribute values corresponding to the respective items.

The tabular data in FIG. 1 includes seven items including the “size” of a previously owned condominium, “nearest station,” “minutes on foot” indicating the time required on foot from the nearest station to the condominium, “age,” “residence floor,” “balcony direction,” and “contract price.” In the example in FIG. 1, three data samples are prepared, and attribute values corresponding to the respective items are described.

In the present embodiment, the data set is described using tabular data.

The prediction analysis includes three steps of processing including “learning,” “prediction,” and “evaluation.”

The “learning” is processing for generating a function (referred to as a prediction model) predicting a value for a prediction target item from an attribute value group corresponding to an input item group for each data sample, for a pre-designated input item group and a pre-designated prediction target item in the tabular data. The learning processing uses a plurality of data samples.

The “prediction” is processing for calculating a prediction value for the data samples using a trained prediction model.

The “evaluation” is processing for comparing and referencing a calculated prediction value and an actual value for a prediction target item to calculate an evaluation value representing the accuracy of the prediction.

### Configuration of Information Processing Apparatus

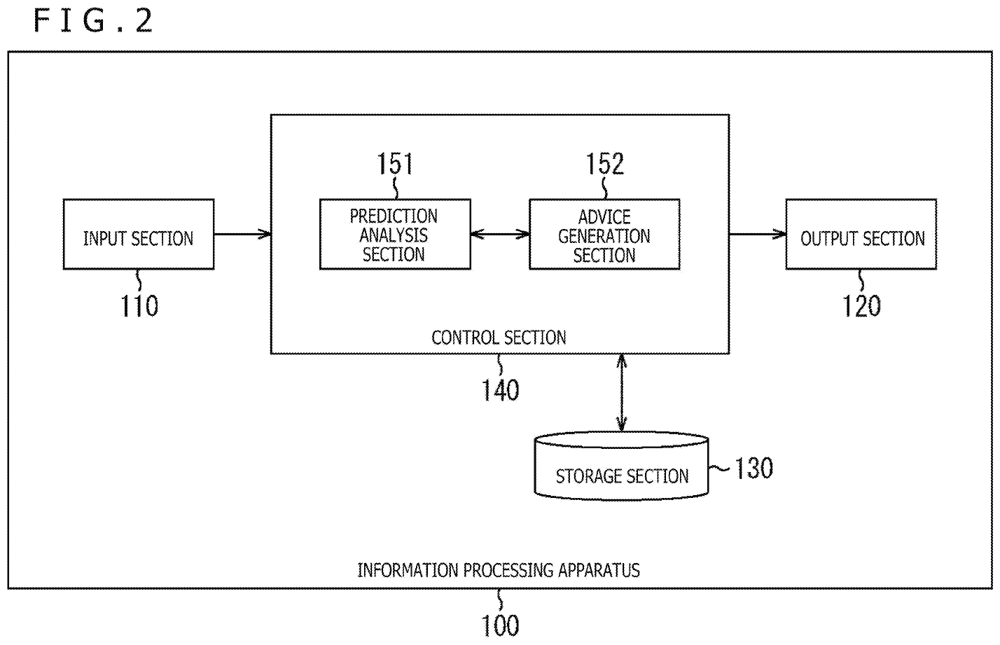

FIG. 2 is a block diagram illustrating a functional configuration example of the information processing apparatus according to the present disclosure.

As illustrated in FIG. 2, an information processing apparatus 100 includes an input section 110, an output section 120, a storage section 130, and a control section 140.

The input section 110 includes a function of receiving information from the user. For example, the input section 110 receives various pieces of information such as tabular data used as a data set. The input section 110 feeds input information to the control section 140.

The output section 120 includes a function of outputting information to the user. For example, the output section 120 outputs various pieces of information such as advice for data set improvement. The output section 120 outputs information fed from the control section 140.

The storage section 130 includes a function of temporarily or permanently storing information. For example, the storage section 130 stores the results of training of the prediction model.

The control section 140 includes a function of controlling the operation of the information processing apparatus 100 as a whole. As illustrated in FIG. 2, the control section 140 includes a prediction analysis section 151 and an advice generation section 152.

The prediction analysis section 151 executes a series of steps of processing for prediction analysis. The advice generation section 152 uses analysis results from the prediction analysis section 151 to generate presentation information for presenting advice for data set improvement.

In the information processing apparatus 100, tabular data to be analyzed is input to the input section 110, and the tabular data is uploaded to the control section 140. Additionally, the user operates the input section 110 to designate a prediction target item in the tabular data. In a case where the prediction target item is a continuous value, regression is performed. In a case where the prediction target item is a categorical value, classification is performed.

An example will be described below in which the contract price of a previously owned condominium in the tabular data in FIG. 1 is predicted on the basis of regression.

### 3. Processing by Prediction Analysis Section

The prediction analysis section 151 processes the following three: a learning data set used for training of the prediction model, an evaluation data set used to evaluate the prediction model, and the prediction target item, to generate an evaluation value list.

The evaluation value list is a list of evaluation values in the learning data set for the prediction model and evaluation values in the evaluation data set, the evaluation values being obtained at a plurality of intermediate points in time while a learning algorithm is in execution. The evaluation value is calculated by executing evaluation processing. Assuming that the intermediate point in time is m=1, . . . , M, the evaluation value list is expressed by the following Expression (1).

[Math. 1]

{(Vₘ^{T},Vₘ^{E})∥m=1, . . . M} (1)

In Expression (1), Vₘ^{T} represents an evaluation value for a learning data set, and VmE represents an evaluation value for an evaluation data set. For regression, as the evaluation value, the average value of 1−error rate (a value obtained by dividing an absolute value error between a prediction value and an actual value by the actual value) is used. For classification, as the evaluation value, an AUC (Area Under the ROC Curve) is used.

Processing by the prediction analysis section 151 will be described below.

First, the prediction analysis section 151 converts each data set into a set of data points. The data points include a pair of a feature amount vector and a label and correspond to a data sample.

The label is a value for a prediction target item in the data sample.

The feature amount vector is a vector obtained by vectorizing the values for the items other than the prediction target item in the data sample and coupling resultant vectors together.

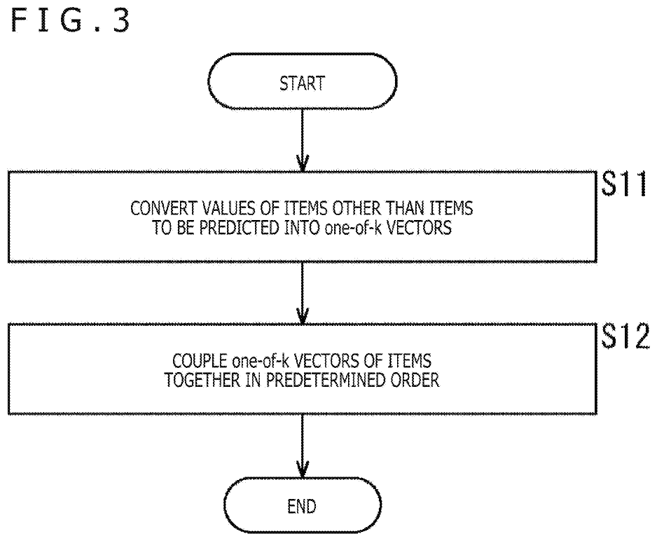

Now, with reference to a flowchart in FIG. 3, feature amount vector generation processing will be described.

In step S11, the prediction analysis section 151 converts the values for the items other than the prediction target item into one-of-k vectors.

The one-of-k vector is a k-dimensional vector in which only one element is 1 and in which the other (k−1) elements are 0.

In the conversion into the one-of-k vectors, possible values for one item are enumerated and a vector that has the same dimension as that of the number of the possible values is created to determine the dimension corresponding to the possible values. In the conversion into the vectors, the dimension corresponding to the value for the item is set to 1, and the other dimensions are set to 0, to convert the value for the item into a one-of-k vector.

For example, in a case where the minutes on foot in the tabular data in FIG. 1 are converted into one-of-k vectors, one minute to 25 minutes are enumerated as possible values for the minutes on foot to prepare 25-dimensional vectors. For example, the first dimension corresponds to one minute on foot. Accordingly, for three minutes on foot, a one-of-k vector is generated in which the third dimension is 1, with the other dimensions being 0.

In such a manner, the prediction analysis section 151 generates a one-of-k vector for each item.

In step S12, the prediction analysis section 151 couples the one-of-k vectors for the respective items together in a predetermined order to generate a feature amount vector.

Here, the contract price in the tabular data in FIG. 1 is set as a prediction target item (label), a feature amount vector obtained by coupling the one-of-k vectors for the items other than the contract price is generated for each property.

Note that, in generation of one-of-k vectors described above, in a case where the possible values for the items are continuous, the values may be rounded off within the range of certain values. For example, the minutes on foot may be organized into five groups of one to five minutes, six to 10 minutes, 11 to 15 minutes, 16 to 20 minutes, and 21 to 25 minutes to allow generation of five-dimensional one-of-k vectors corresponding to the respective groups.

Then, the prediction analysis section 151 trains the prediction model.

Here, i represents an index for a data sample (the number of data samples n), the value of the contract price is represented by Expression (2), and the feature amount vector is represented by Expression (3).

[Math. 2]

yᵢ∈R (2)

[Math. 3]

(xᵢⱼ)=xᵢ∈R^{d} (3)

In Expression (3), R represents a real number, d represents the number of dimensions of a feature amount vector, and j represents the index of the dimension.

Then, the i-th data point is represented by the following Expression (4).

[Math. 4]

(xᵢ,yᵢ) (4)

Additionally, the prediction model, that is, a function of calculating the value of the contract price for the feature amount vector xᵢ is represented by Expression (5), and parameters for the prediction model are represented by Expression (6).

[Math. 5]

f(xᵢ;w) (5)

[Math. 6]

w∈R^{D} (6)

In Expression (6), D represents the number of parameters.

As the prediction model f, any of various possible functions may be used, and, for example, a neural network is used.

Parameter learning is implemented using the learning data set. For example, with a mean square error used as an error function, a gradient method is executed to determine parameters for the prediction model.

In general, in the learning algorithm including the gradient method, parameter update processing is repeatedly executed. The evaluation value list is generated by calculating, for the prediction model on which each step of parameter update processing has been executed, an evaluation value for learning data set and an evaluation value for the evaluation data set.

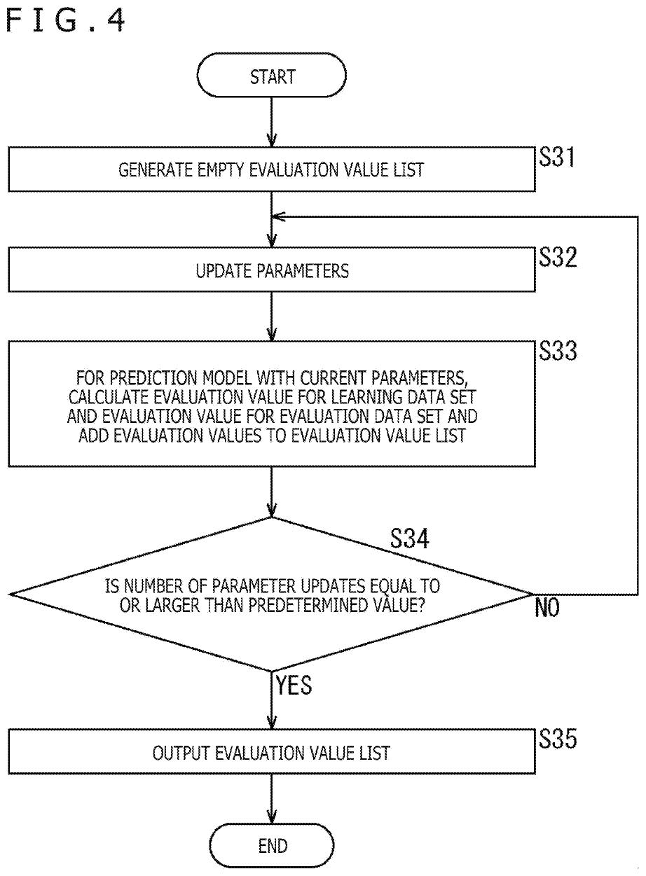

Now, evaluation value generation processing will be described with reference to a flowchart in FIG. 4.

In step S31, the prediction analysis section 151 generates an empty evaluation value list.

In step S32, the prediction analysis section 151 updates the parameters for the prediction model.

In step S33, for the prediction model with the current parameters, the prediction analysis section 151 calculates an evaluation value for the learning data set and an evaluation value for the evaluation data set and adds the evaluation values to the evaluation value list.

In step S34, the prediction analysis section 151 determines whether the number of parameter updates is equal to or larger than a predetermined value.

In a case where the number of parameter updates is not equal to or larger than the predetermined value, the processing returns to step S32 to repeat update of the parameters and calculation of the evaluation values for the learning data set and the evaluation data set.

On the other hand, in a case where the number of parameter updates is equal to or larger than the predetermined value, the processing proceeds to step S35, where the prediction analysis section 151 feeds the calculated evaluation value list to the output section 120. The output section 120 outputs the evaluation value list.

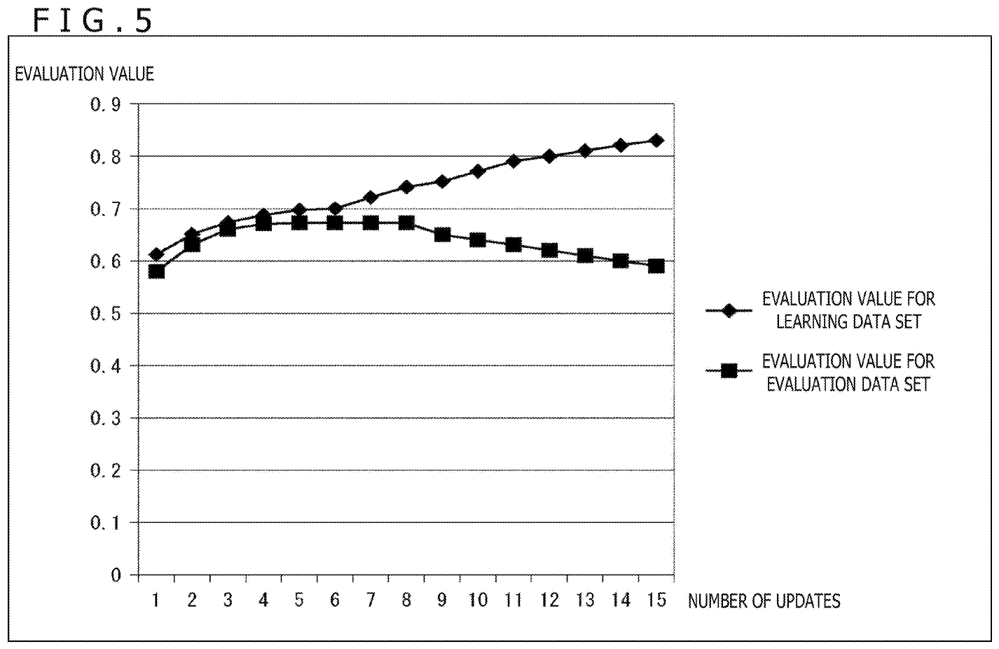

FIG. 5 is a diagram illustrating a graph of the evaluation value list as an output example of the evaluation value list from the output section 120.

In the graph in FIG. 5, the evaluation value for the learning data set and the evaluation value for the evaluation data set are plotted for every number of times of parameter updates.

As illustrated in FIG. 5, the evaluation value for the learning data set increases (becomes closer to 1) as the parameter update is repeated. On the other hand, the evaluation value for the evaluation data set does not increase in spite of the repeated parameter updates, and the difference between the evaluation value for the evaluation data set and the evaluation value for the learning data set increases as the parameter update is repeated.

Training of the prediction model is performed using the learning data set, and thus, the prediction model more successfully adapts itself to the learning data set. Thus, the difference between the evaluation value for the learning data set and the evaluation value for the evaluation data set tends to increase as the parameter update is repeated. This tendency depends on the number of data samples.

As described above, the prediction analysis section 151 calculates the evaluation value list.

### 4. Advice Generation Processing (for Improvement of Learning Data Set)

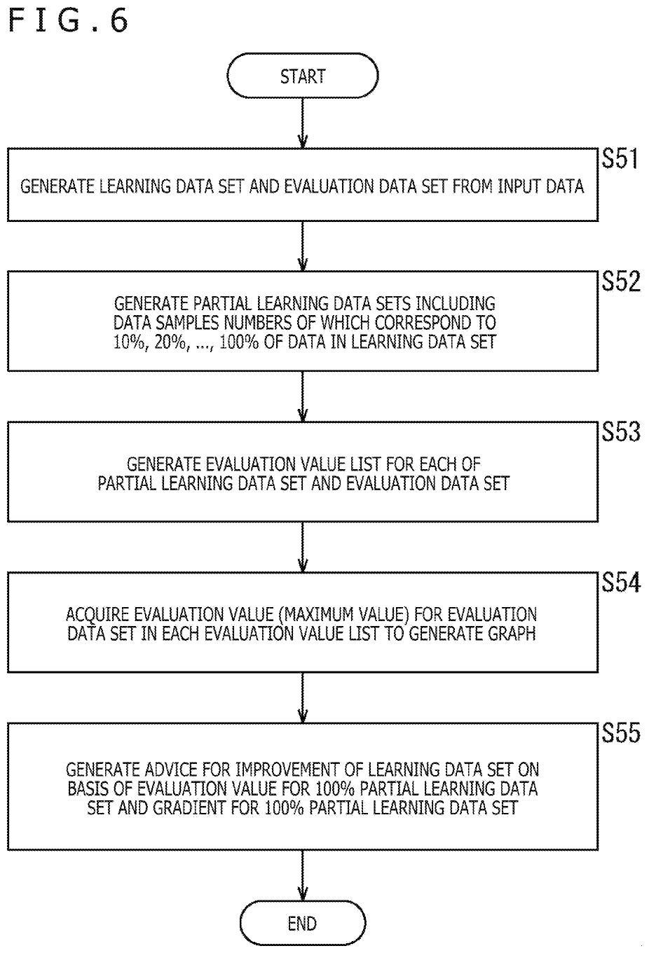

Now, with reference to a flowchart in FIG. 6, processing will be described in which the above-described evaluation value list is used to generate advice for improvement of the learning data set.

In step S51, the control section 140 generates a learning data set and an evaluation data set from input data (tabular data) input by the input section 110. For example, the control section 140 performs, for example, random sorting of the data samples in the tabular data into 8:2 to generate a learning data set and an evaluation data set.

In step S52, the control section 140 generates data sets each including 10%, 20%, 30%, 40%, 50%, 60%, 70%, 80%, 90%, or 100% in number of the data samples in the learning data set. Accordingly, the data set including some of the data samples in the learning data set is hereinafter referred to as a partial learning data set. Here, 10 partial learning data sets are generated. Note that the number of data samples in the 100% partial learning data set may be increased by the user in accordance with advice described below. Consequently, the number of data samples in the 100% partial learning data set can be said to be the current number of data samples.

In step S53, the prediction analysis section 151 of the control section 140 generates an evaluation value list described with reference to the flowchart in FIG. 5, for each of the partial learning data sets and for the evaluation data set. In other words, the prediction analysis section 151 calculates an evaluation value for the evaluation data set, for each of the 10% to 100% partial learning data sets.

In step S54, the prediction analysis section 151 acquires the maximum value of the evaluation value for the evaluation data set in each evaluation value list to generate a graph of the evaluation values. Specifically, in the graph generated, the maximum value of the evaluation values in the evaluation data set in the evaluation value list (the maximum value is hereinafter also simply referred to as the evaluation value) is plotted for each of the 10% to 100% partial learning data sets.

In step S55, the advice generation section 152 generates presentation information for presenting advice for improvement of the learning data set, on the basis of the evaluation value for the 100% partial learning data set in the generated graph of the evaluation values and of the gradient of the evaluation value. The generated presentation information is output by the output section 120.

Here, the evaluation value for the 100% partial learning data set is the maximum value of the evaluation values in the evaluation data set in the evaluation value list, for the 100% partial learning data set. Additionally, the gradient of the evaluation value for the 100% partial learning data set refers to the difference between the evaluation value for the 100% partial learning data set and the evaluation value for the 90% partial learning data set.

Specifically, the advice generation section 152 generates advice (presentation information) for improvement of the number of feature amounts (items) in the learning data set, on the basis of a magnitude relationship between the evaluation value for the 100% partial learning data set and a first threshold.

Additionally, the advice generation section 152 generates advice (presentation information) for improvement of the number of data samples in the learning data set, on the basis of a magnitude relationship between the gradient of the evaluation value for the 100% partial learning data set and a second threshold. The second threshold is a value determined on the basis of the magnitude of the evaluation value for the 100% partial learning data set.

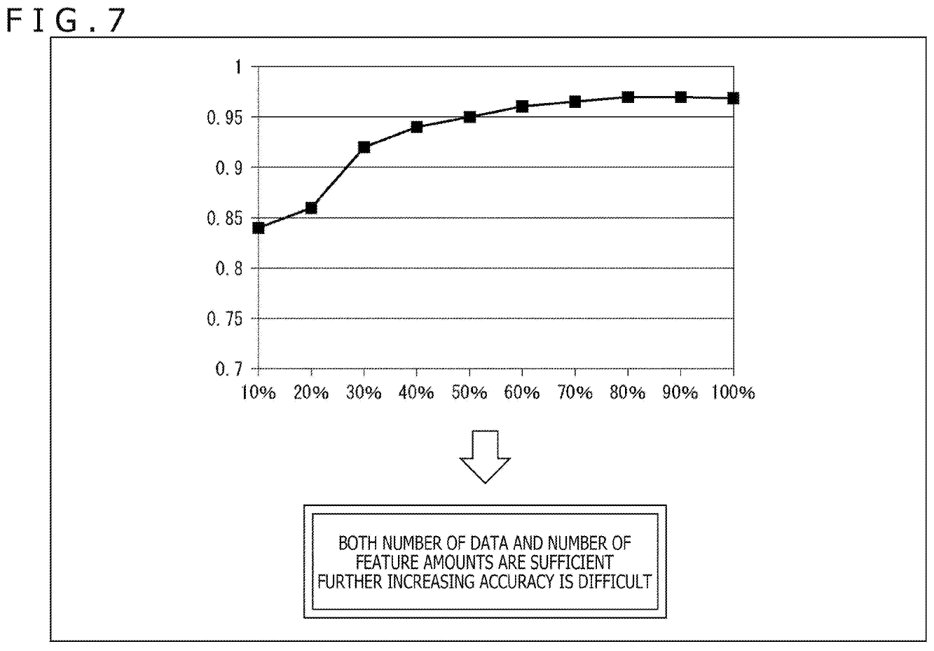

FIGS. 7 to 10 are each a diagram illustrating a graph of the evaluation value and an example of presented advice.

In an example in FIG. 7, in the graph of the evaluation value, the evaluation value for the 100% partial learning data set (hereinafter referred to as a 100% evaluation value) is larger than the first threshold, and the gradient of the 100% evaluation value (hereinafter simply referred to as the gradient) is smaller than the second threshold.

In this case, advice is presented indicating that the number of data samples and the number of feature amounts in the learning data set are sufficient, such as “Both numbers of data and feature amounts are sufficient, and further increasing efficiency is difficult,” as illustrated in FIG. 7.

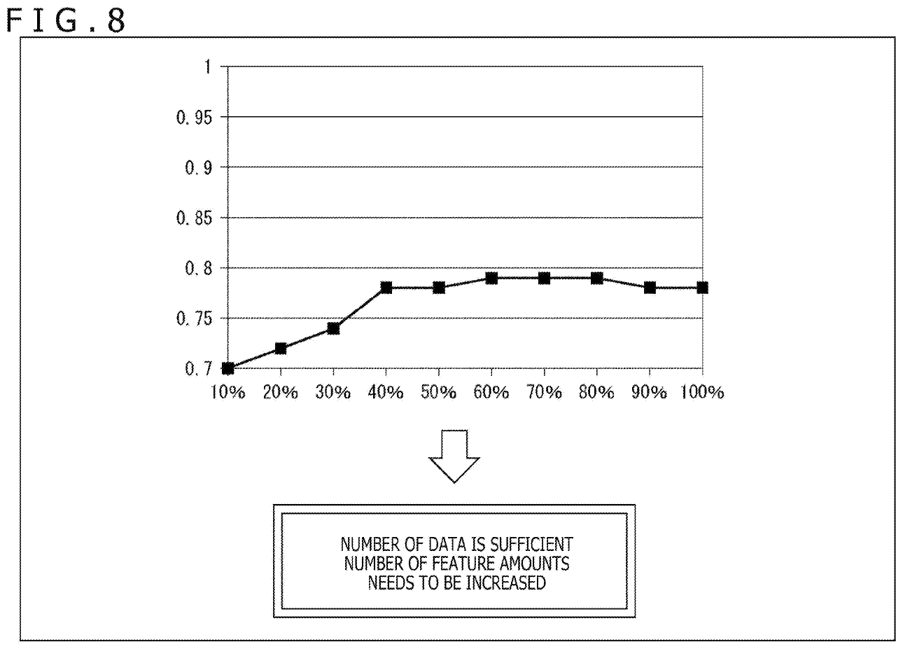

In an example in FIG. 8, in the graph of the evaluation value, the 100% evaluation value is smaller than the first threshold, and the gradient is smaller than the second threshold.

In this case, advice is presented indicating that the number of data samples in the learning data set is sufficient, while the number of feature amounts is insufficient, such as “Number of data is sufficient. Number of feature amounts needs to be increased,” as illustrated in FIG. 8.

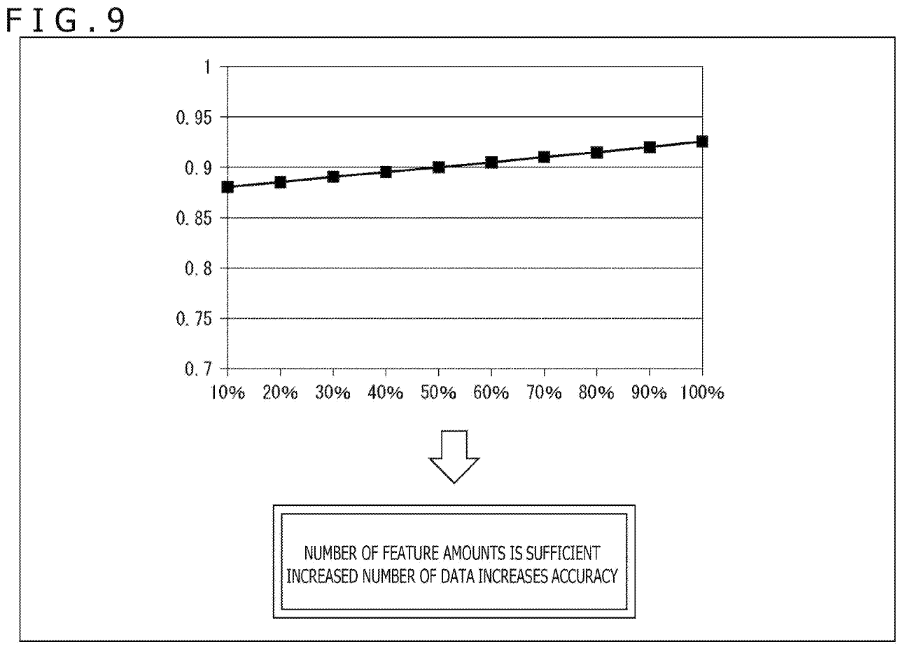

In an example in FIG. 9, in the graph of the evaluation value, the 100% evaluation value is larger than the first threshold, and the gradient is larger than the second threshold.

In this case, advice is presented indicating that the number of feature amounts in the learning data set is sufficient, while the number of data samples is insufficient, such as “Number of feature amounts is sufficient. Accuracy is improved by increasing number of data samples,” as illustrated in FIG. 9.

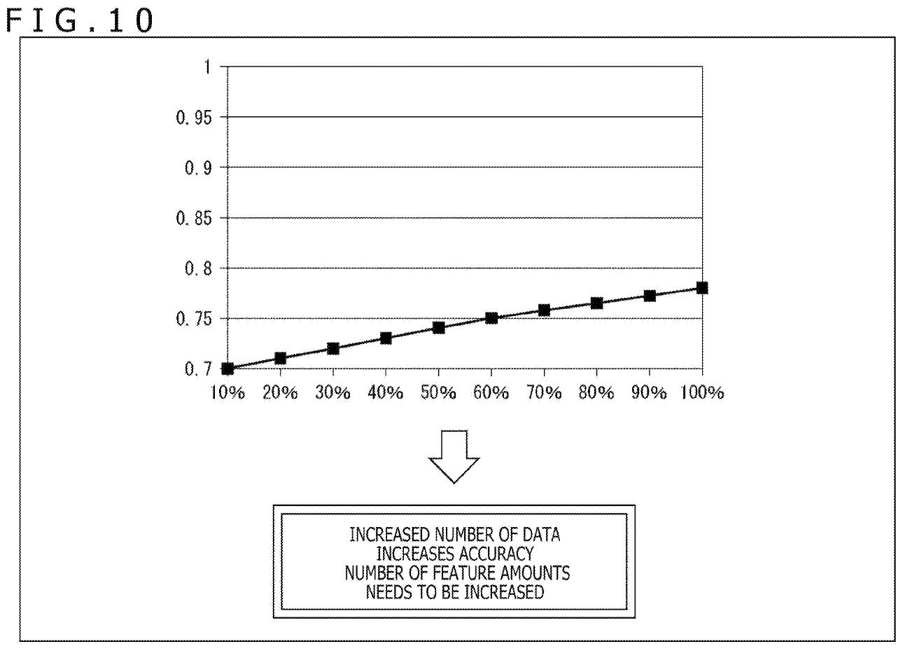

In an example in FIG. 10, in the graph of the evaluation value, the 100% evaluation value is smaller than the first threshold, and the gradient is larger than the second threshold.

In this case, advice is presented indicating that both the numbers of data samples and feature amounts in the learning data set are insufficient, such as “Accuracy is improved by increasing number of data. Number of feature amounts needs to be increased,” as illustrated in FIG. 10.

According to the processing described above, the advice for improvement of the learning data set is presented, enabling improvement of the learning data set to be facilitated. In other words, the user can easily determine whether to increase the number of data samples or feature amounts (items) or not, even without domain knowledge of a prediction problem to be solved or expertise of prediction analysis, and can easily increase the prediction accuracy.

The above description assumes that, as the gradient, a difference corresponding to the evaluation value for the 100% partial learning data set and the evaluation value for the 90% partial learning data set is used.

The present disclosure is not limited to this gradient, and a difference between the evaluation value for the 100% partial learning data set and the evaluation value of a partial learning data set smaller than the 90% partial learning data set, for example, the 80% partial learning data set, may be used as the gradient.

Further, time-series prediction may be used to determine an evaluation value for a partial learning data set larger than the 100% partial learning data set, for example, a 110% partial learning data set, and to use, as the gradient, a difference between the evaluation value for the 110% learning data set and the evaluation value for the 100% learning data set.

Additionally, the graph in FIG. 5 indicates that, with respect to the number of parameter updates, more significant insufficiency of the number of data samples is indicated by a stronger tendency of increase in the difference between the evaluation value for the learning data set and the evaluation value for the evaluation data set. Thus, as the gradient, the rate, with respect to the number of parameter updates, of increase in a difference between the evaluation value for the learning data set and the evaluation value for the evaluation data set as illustrated in the graph in FIG. 5 may be used. Additionally, the magnitude of the difference between the evaluation value for the learning data set and the evaluation value for the evaluation data set may simply be used as the gradient.

### 5. Advice Generation Processing (Addition of Feature Amount)

In the above-described advice generation processing, in a case where the 100% evaluation value is smaller than the first threshold, the advice indicating that the number of feature amounts is insufficient is presented to prompt the user to increase the number of feature amounts (items).

Now, described is an example in which advice that presents the user with an item that reduces the prediction accuracy and the value of the prediction accuracy to prompt addition of an item that avoids a decrease in prediction accuracy is generated.

Specifically, an example will be described in which, in a case where inclusion of the attribute value (simply referred to as the value) of a particular feature amount (item) reduces the prediction accuracy, the value of the feature amount is presented to the user and a prediction case of a data sample including the value of the feature amount is also presented to the user.

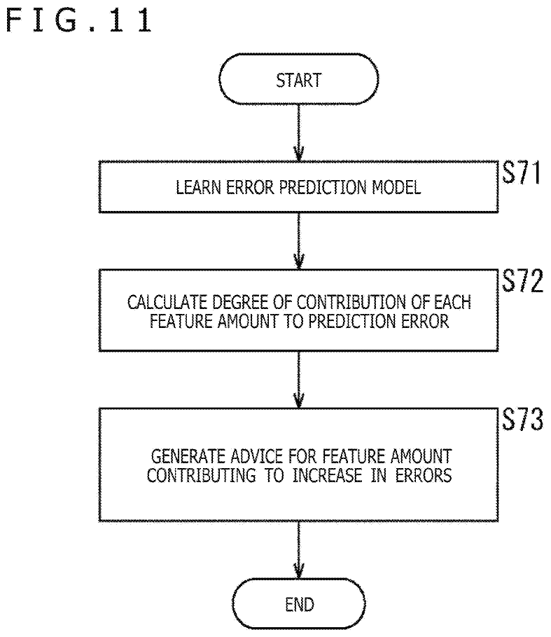

FIG. 11 is a flowchart illustrating processing for generating advice prompting addition of a feature amount.

In step S71, the prediction analysis section 151 trains an error prediction model estimating a prediction error in the prediction model, in order to identify the value of a feature amount that reduces the prediction accuracy when included.

Here, i is the index of a data sample (the number of data samples n), and the value of the contract price is represented by Expression (7). Additionally, a prediction value for the contract price (predicted contract price) provided by the trained prediction model f is represented by Expression (8), and the feature amount vector is represented by Expression (9).

[Math. 7]

yᵢ∈R (7)

[Math. 8]

zᵢ∈R (8)

[Math. 9]

(xᵢⱼ)=xᵢ∈R^{d} (9)

In Expression (9), d represents the number of dimensions of the feature amount vector, and j represents the index of the dimension.

Then, the i-th data point is represented by Expression (10).

[Math. 10]

(xᵢ,|yᵢ−zᵢ|) (10)

Additionally, a function of calculating a prediction value for an absolute value error between the predicted contract price and the actual contract price with respect to the error prediction model, that is, the feature amount vector xᵢ, is represented by Expression (11).

[Math. 11]

g(xᵢ;w′) (11)

In Expression (11), w′ represents the number of parameters for the error prediction model.

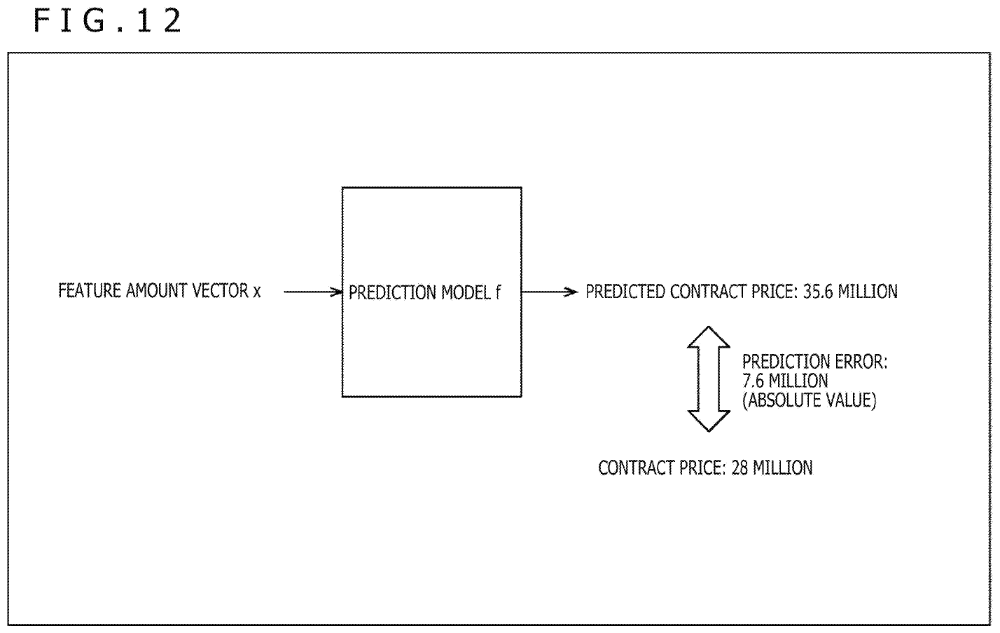

For example, as illustrated in FIG. 12, in a case where the feature amount vector x is input to the trained prediction model f, a predicted contract price of 35.6 million is output. In a case where the actual contract price is 28 million, the prediction error (absolute value error) is 7.6 million. In such a manner, an error prediction model g estimating a prediction error in the prediction model f is trained using the feature amount vector as input data.

Any of various possible functions may be used as the error prediction model g, and for example, linear regression is used.

Parameter learning is implemented using the learning data set. For example, with the mean square error used as an error function, the gradient method is executed to determine parameters for the error prediction model.

After training of the error prediction model, in step S72, the prediction analysis section 151 uses the error prediction model to calculate the degree of contribution of the value of each feature amount to the prediction error. The value of the feature amount corresponds to the dimension of the feature amount vector.

As the degree of contribution, for example, the value of a parameter corresponding to each feature amount of the error prediction model using linear regression is used. The value of a feature amount contributing significantly to an increase in prediction error is identified as a value reducing the prediction accuracy. In the example of linear regression, the value of a feature amount for which the corresponding parameter has a large value is identified. At this time, the value of the feature amount may be identified with the large number of data samples including the value of the feature amount taken into account.

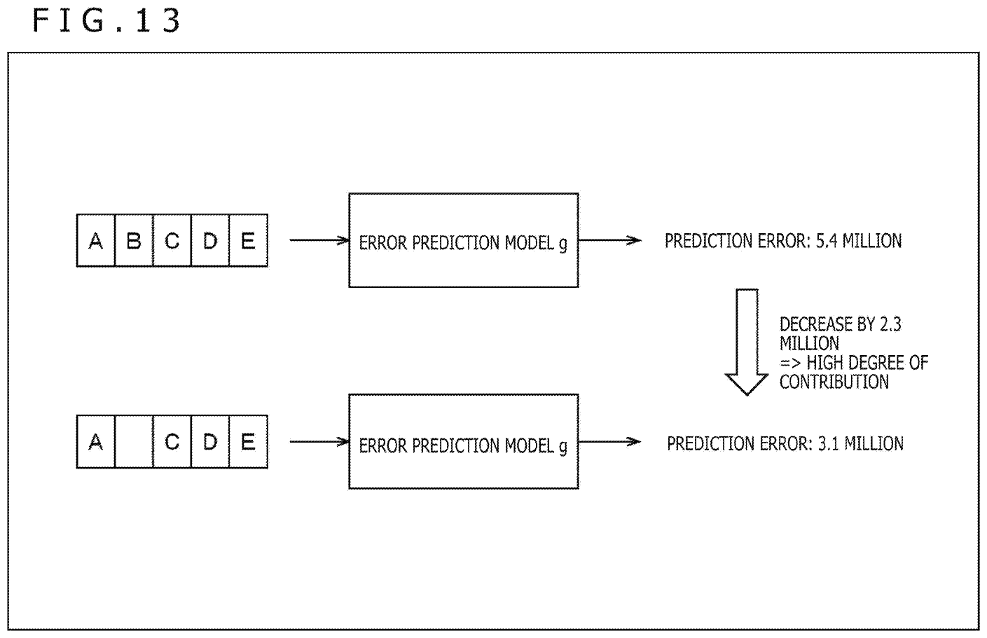

Additionally, as illustrated in FIG. 13, the degree of contribution of the value of the feature amount may be calculated.

In an example in the upper stage of FIG. 13, when values A, B, C, D, and E of a certain feature amount are input to the error prediction model g, a prediction error of 5.4 million is output. On the other hand, in an example in the lower stage of FIG. 13, when the values A, C, D, and E of the feature amount with the value B masked are input to the error prediction model g, a prediction error of 3.1 million is output. In other words, in the example in FIG. 13, masking the value B of the feature amount reduces the prediction error by 2.3 million. In this case, the degree of contribution of the value B of the feature amount is calculated according to the magnitude of the prediction error.

When the value of the feature amount contributing to an increase in error is identified, the advice generation section 152 generates, in step S73, presentation information for presenting advice for the feature amount contributing to an increase in error. The presentation information generated is output by the output section 120.

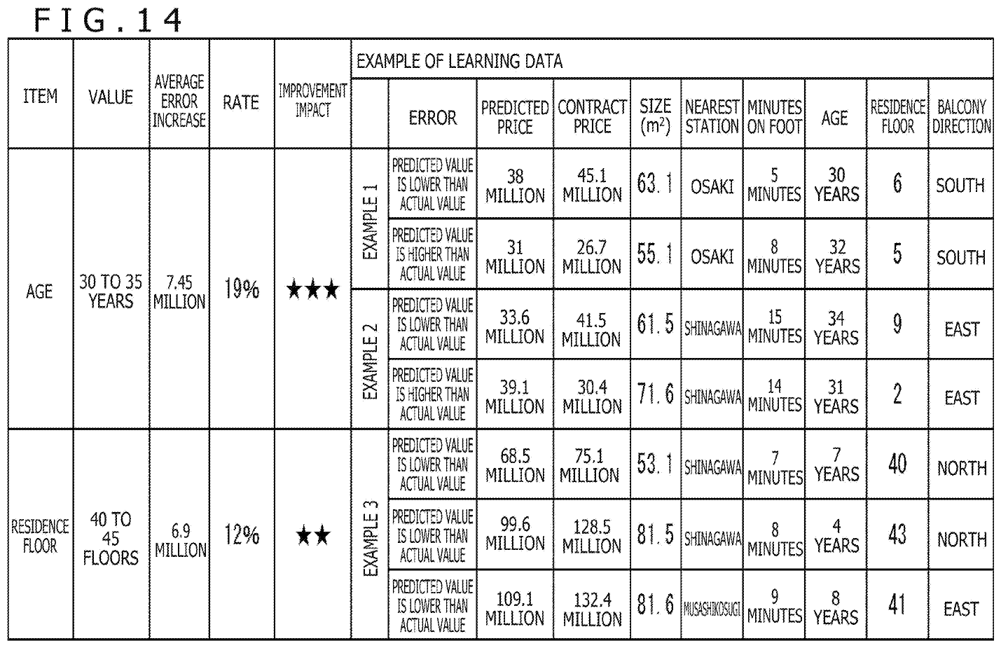

FIG. 14 is a diagram illustrating an example of presentation of advice for addition of a feature amount.

In an example in FIG. 14, the following are presented as the presentation information: a feature amount (item) contributing to an increase in error and the value of the feature amount, an average error increase, a rate, improvement impact, and an example of learning data.

The average error increase indicates the amount by which the average error in data samples with the value of a feature amount contributing to an increase in error is larger than the average error in all the data samples (the average of the prediction error).

The rate indicates the rate of data samples with the values of feature amounts contributing to an increase in error, with respect to all the data samples.

The improvement impact indicates a score determined on the basis of the product of the average error increase and the rate described above, and is represented by the number of stars in the example in FIG. 14.

The example of learning data indicates a data sample including the value of a feature amount contributing to an increase in error and a prediction result based on the data sample.

In the example of learning data, in particular, only the feature amount (item) contributing more significantly to the prediction by the prediction model f is presented as a data sample. In the example in FIG. 14, the indicated feature amounts include the size, the nearest station, the age, the residence floor, and the balcony direction.

Additionally, in the example of learning data, a pair of two data samples is displayed, the data samples having a higher similarity in terms of the feature amount vector and involving prediction values deviating from the actual value (prediction value−actual value) in the opposite directions, that is, respectively having positive and negative prediction errors.

In the example in FIG. 14, as the values of items contributing to an increase in error, an age of 30 to 35 years and a residence floor of 40th to 45th floors are indicated.

For properties with old ages, the contract price may vary depending on the state of maintenance by the owner. However, no information (feature amount) indicating the state of maintenance is included in the tabular data, and thus, such properties involve a significant prediction error.

In the example of learning data regarding the age (30 to 35 years), as example 1, a pair of two data samples including Osaki as the nearest station, several minutes on foot, and the like is displayed, the data samples having a higher similarity and involving prediction values deviating from the actual value in the opposite directions. Likewise, as example 2, a pair of two data samples including Shinagawa as the nearest station, approximately 15 minutes on foot, and the like is displayed, the data samples having a higher similarity and involving prediction values deviating from the actual value in the opposite directions.

Additionally, properties with high residence floors located on ultra high floors in high-rise condominiums have additional values compared to normal properties. However, information (feature amount) indicating the ultra high floors is not included in the tabular data, and thus, such properties involve a significant prediction error (the prediction value is lower than the actual value).

In the example of learning data regarding the residence floor (40th to 45th floors), as example 3, three data samples are displayed all of which indicate that the predicted price is lower than the actual contract price.

Presenting the presentation information as described above enables the user to be prompted to add a feature amount that avoids a decrease in prediction accuracy.

Additionally, as an example of learning data, items with higher contribution to the prediction by the prediction model are presented. Thus, unimportant items are not presented, and the user can be made to intuitively recognize the entire picture of the learning data set required to increase the prediction accuracy.

Furthermore, as an example of learning data, a pair of two data samples is displayed, the data samples having a higher similarity and involving prediction values deviating from the actual value in the opposite directions. Thus, addition of a feature amount representing a difference between the two data samples can be prompted.

### 6. Application Example

An application example of the above-described embodiment will be described below.

### (1) Automatic Presentation of Additional Candidate for Feature Amount (Item)

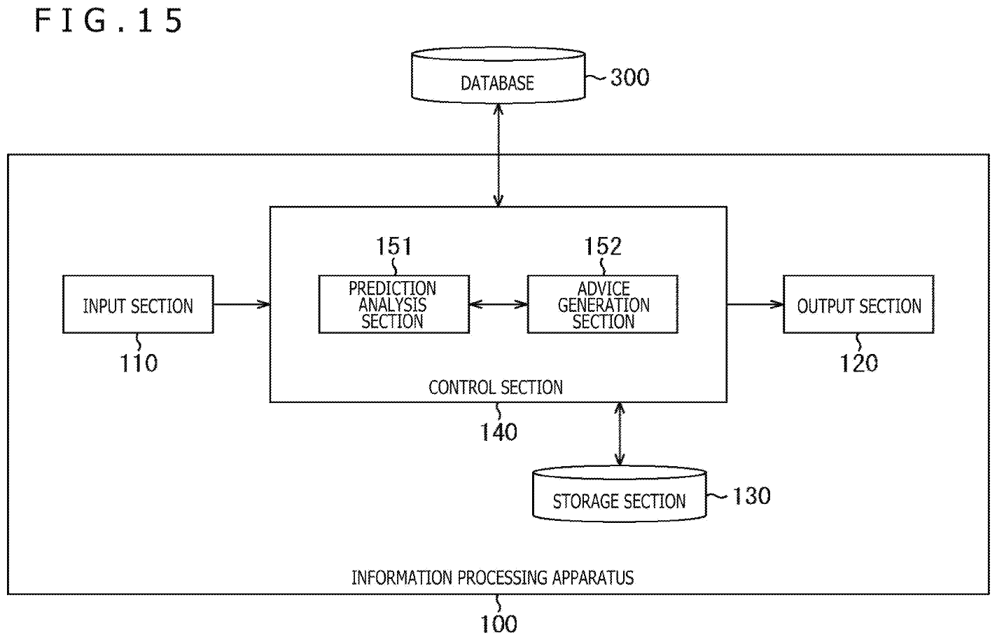

FIG. 15 illustrates the information processing apparatus 100 connected to a database.

A database 300 holds a plurality of tables expressed by tabular data. The tabular data used for prediction analysis is generated on the basis of the tables held in the database 300.

The advice generation section 152 acquires, from the database 300, tables including the values of the feature amounts identified to contribute to an increase in error when generating advice (presentation information) prompting addition of a feature amount as described with reference to FIG. 14. The advice generation section 152 calculates correlation values representing correlations between the feature amount identified to contribute to an increase in error and other feature amounts.

The advice generation section 152 presents a feature amount with a smaller absolute correlation value as an additional candidate for a feature amount. Feature amounts with a low correlation are considered to represent different pieces of information and expected to include information mitigating an increase in error.

### (2) Case of Classification

The example in which the regression is performed as prediction analysis has been described above.

In the case of classification, the calculation of the difference between the prediction value and the actual value (prediction error) as described with reference to FIG. 14 cannot be performed.

Thus, the prediction error is defined as (1.0-prediction probability of correct label) to allow identification of a feature amount contributing significantly to an increase in the prediction error.

For example, a label for classification is assumed to take two values, “withdrawal” and “retention.” For data with the “withdrawal” label, a withdrawal prediction probability p is calculated, and 1.0−p is determined to be an error. For data with the “retention” label, a continue prediction probability q is calculated, and 1.0−q is determined to be an error.

However, in a case where the number of data with each label are biased, the error calculation technique as described above poses a problem. For example, in a case where data with the “withdrawal” label accounts for 20% of the total data and data with the “retention” label accounts for 80% of the total data, the withdrawal prediction probability p is likely to be estimated to be smaller than the retention prediction probability q, leading to a significant error.

Thus, the following two measures are possible.

### (Measure 1)

A first measure involves removing a bias in learning data using the following procedure.

1. A learning data set with the labels in an adjusted ratio is prepared.

2. Training using the learning data set is performed to generate a prediction model fa.

3. For the prediction model fa, an error prediction model fb is generated that estimates the error defined as described above.

4. For the error prediction model fb, the feature amount contributing to an increase in error is identified.

5. Subsequently, processing similar to the processing for the regression is executed.

### (Measure 2)

A second measure involves correcting an error value using the following procedure.

1. The rate of data with the correct label in the learning data set is denoted by r, and the number of labels is denoted by n.

2. As a prediction error, max(1−prediction probability of correct label/r/n, 0) is used.

Here, max(x, y) is a function returning x for x>y, y for x<y, and x for x=y. The use of the function can prevent the prediction error from assuming a minus value.

In the above-described example, for the withdrawal prediction probability p, r=0.2 and n=2 are established, and max(1-2.5p, 0) is an error with respect to the withdrawal prediction probability p of the data with the “withdrawal” label. On the other hand, for the retention prediction probability q, r=0.8 is established, and max(1-0.625p, 0) is an error with respect to the retention prediction probability q of the data with the “retention” label.

3. Subsequently, processing similar to the processing for the regression is executed.

Note that another technique may be used to correct the error value.

As described above, the feature amount contributing significantly to an increase in error can be identified.

As described above, the prediction accuracy of the prediction analysis is determined mainly by the following three factors.

1. Prediction model used for prediction

2. Quantity and quality of the learning data set used to construct the prediction model

3. Difficulty in the original prediction target

In the above-described embodiment, an increase in prediction accuracy is realized by the improvement of the learning data set in 2. The present disclosure is not limited to this configuration, and for effective improvement of 2. and 3. in a shorter period of time, consultation with an external expert may be preferred.

On the other hand, there are not many such experts with expertise in the field of prediction analysis. Thus, a mechanism is required in which a consultant side providing consultation shares knowledge to improve the quality of consultation.

Thus, an embodiment will be described in which the consultant side shares knowledge to improve the quality of consultation.

### 7. Configuration of Prediction Analysis System

### System Overview

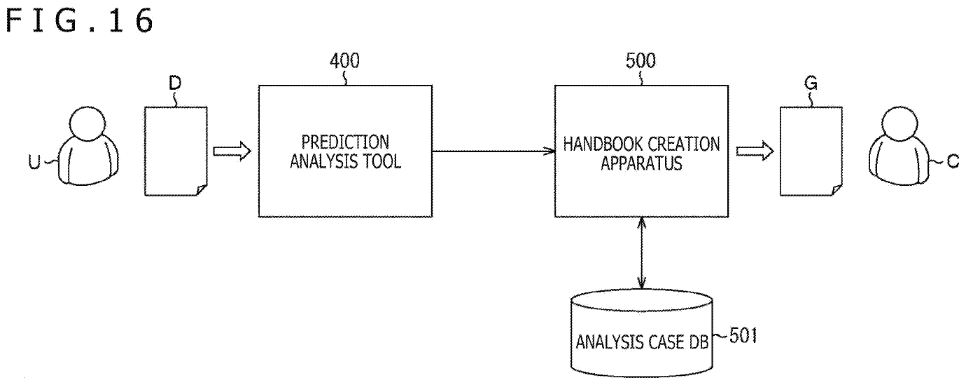

FIG. 16 is a diagram illustrating an overview of a prediction analysis system of the present embodiment.

In FIG. 16, a user U performs prediction analysis using a prediction analysis tool 400. Specifically, the user U creates a data set D and causes the prediction analysis tool 400 to perform “learning” and “evaluation.”

The prediction analysis tool 400 is implemented, for example, by software activated on a personal computer (PC) held by a company to which the user U belongs.

Analysis information (the statistic of the data set D created by the user U and the results of evaluation of the prediction analysis by the prediction analysis tool 400) obtained by the prediction analysis is fed to a handbook creation apparatus 500 via a network, for example, the Internet.

Additionally, by inputting the usage status of the prediction analysis (the purpose of the prediction analysis, the department to which the user U belongs, and the like), the user U can add the input information to analysis information fed to the handbook creation apparatus 500.

The handbook creation apparatus 500 includes a PC, a tablet terminal, or the like operated by a consultant C providing consultation for the prediction analysis performed by the user U.

The handbook creation apparatus 500 presents a handbook G for advising the consultant C on consultation for the prediction analysis performed by the user U, on the basis of the contents of the analysis information from the prediction analysis tool 400.

The handbook G includes advice related to the prediction analysis performed by the user U, analysis information (cases) that is similar to the analysis information from the prediction analysis tool 400 and that is acquired from an analysis case database (DB) 501, and the like. The analysis case DB 501 stores a plurality of pieces of analysis information obtained in the past.

The consultant C can provide consultation related to the prediction analysis performed by the user U, on the basis of the contents of the presented handbook G.

Note that the prediction analysis system in FIG. 16 is partitioned into a user U-side configuration and a consultant C-side configuration but that such partitioning is not necessarily required and that persons handling the respective configurations may partition the system as appropriate.

### Configuration Example of Handbook Creation Apparatus

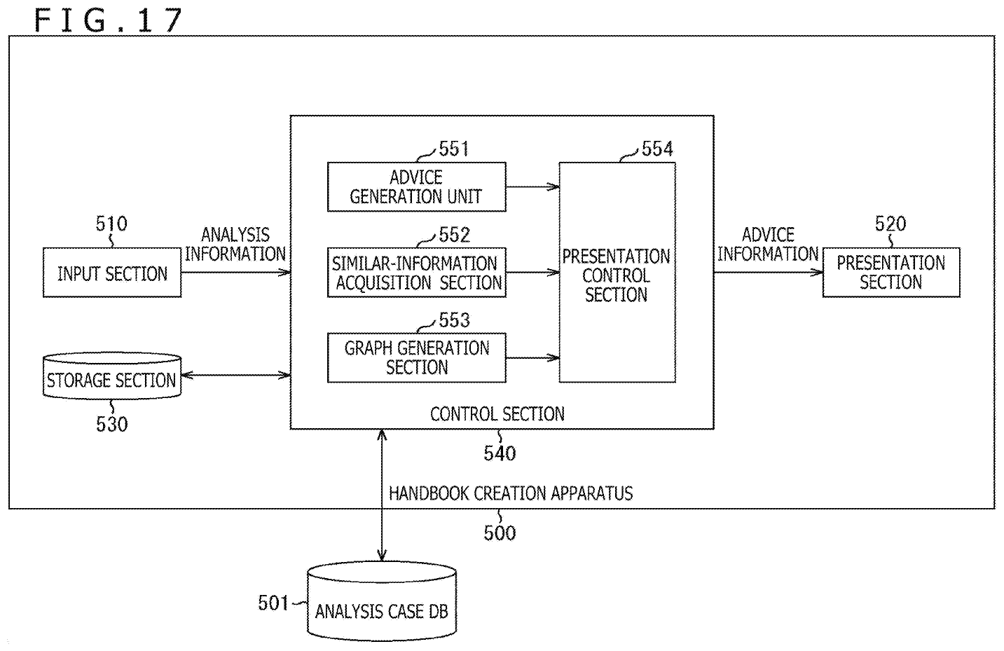

FIG. 17 is a block diagram illustrating a functional configuration example of the handbook creation apparatus 500.

As illustrated in FIG. 17, the handbook creation apparatus 500 includes an input section 510, a presentation section 520, a storage section 530, and a control section 540.

The input section 510 receives various kinds of input information such as the analysis information from the prediction analysis tool 400. The input section 510 feeds the input information to the control section 540.

The presentation section 520 includes a function of presenting the information fed from the control section 540. For example, the presentation section 520 presents a handbook including advice information used to advise on consultation for the prediction analysis.

The presentation section 520 may be configured, for example, as a monitor to present information through display on a screen or as a speaker to audibly present information. Alternatively, the presentation section 520 may be configured as a printer to present information through printing on print media such as paper.

The storage section 530 includes a function of temporarily or permanently storing information. For example, the storage section 530 temporarily stores the analysis information from the prediction analysis tool 400. The analysis information obtained in the past and stored in the storage section 530 is, for example, associated with input information input by the consultant C, and resultant information is stored in the analysis case DB 501.

The control section 540 includes a function of controlling the operation of the handbook creation apparatus 500 as a whole. Specifically, the control section 540 controls, on the basis of the contents of the analysis information from the prediction analysis tool 400, presentation of advice information regarding consultation for the prediction analysis by the prediction analysis tool 400, by which the analysis information has been obtained.

The control section 540 includes an advice generation section 551, a similar-information acquisition section 552, a graph generation section 553, and a presentation control section 554.

The advice generation section 551 generates advice related to the prediction analysis performed by the user U, on the basis of the contents of the analysis information from the prediction analysis tool 400.

The similar-information acquisition section 552 acquires, from the analysis information stored in the analysis case DB 501, similar information similar to the analysis information from the prediction analysis tool 400.

The graph generation section 553 generates, on the basis of the contents of the analysis information from the prediction analysis tool 400, an accuracy evaluation graph used to evaluate the prediction accuracy of the prediction analysis performed by the user U.

The presentation control section 554 is fed with the advice generated by the advice generation section 551, the similar information acquired by the similar-information acquisition section 552, and the accuracy evaluation graph generated by the graph generation section 553.

The presentation control section 554 controls the presentation, to the presentation section 520, of the advice, the similar information, and the accuracy evaluation graph fed respectively from the advice generation section 551, the similar-information acquisition section 552, and the graph generation section 553.

Each step of processing in the prediction analysis system will be described below.

### 8. Analysis Information Transmission Processing

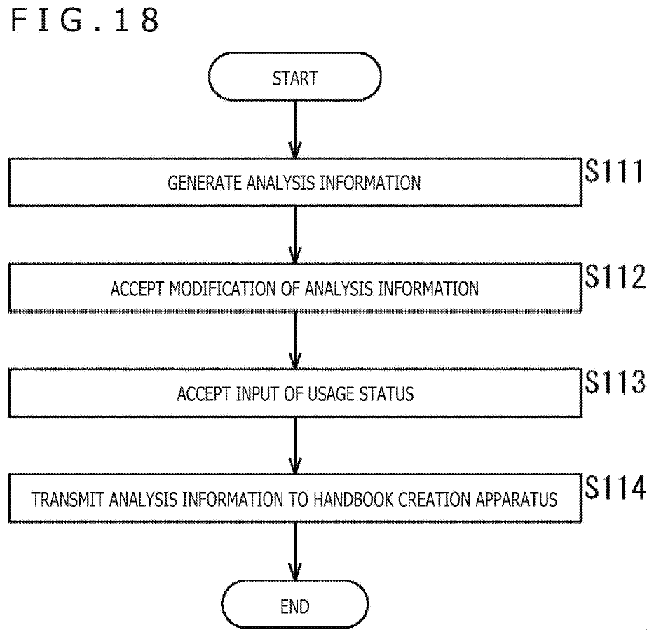

First, with reference to a flowchart in FIG. 18, analysis information transmission processing by the prediction analysis tool 400 will be described.

When the user U performing the prediction analysis inputs a data set to the prediction analysis tool 400, the prediction analysis tool 400 performs, in step S111, prediction analysis using an input data set, to generate analysis information. The prediction analysis tool 400, for example, displays the generated analysis information on a display section not illustrated or the like to allow the user U to check the analysis information.

In step S112, the prediction analysis tool 400 accepts modification of the analysis information according to a modification operation by the user U checking the analysis information. This processing is executed as needed.

Data erroneously input by the user U may be present in the data set, and thus modification can be made in which, for example, data having the largest to fifth largest values and the smallest to fifth smallest values for a specific item in the data set is removed.

In step S113, the prediction analysis tool 400 accepts the input of usage status of the prediction analysis according to an input operation by the user U. The input usage status of the prediction analysis is added to the generated analysis information. This processing is also executed as needed and may be performed in the handbook creation apparatus 500.

In step S114, in accordance with a transmission instruction from the user U, the prediction analysis tool 400 transmits, to the handbook creation apparatus 500, the analysis information with the usage status of the prediction analysis added thereto.

The analysis information transmission processing is executed as described above.

### Example of Analysis Information

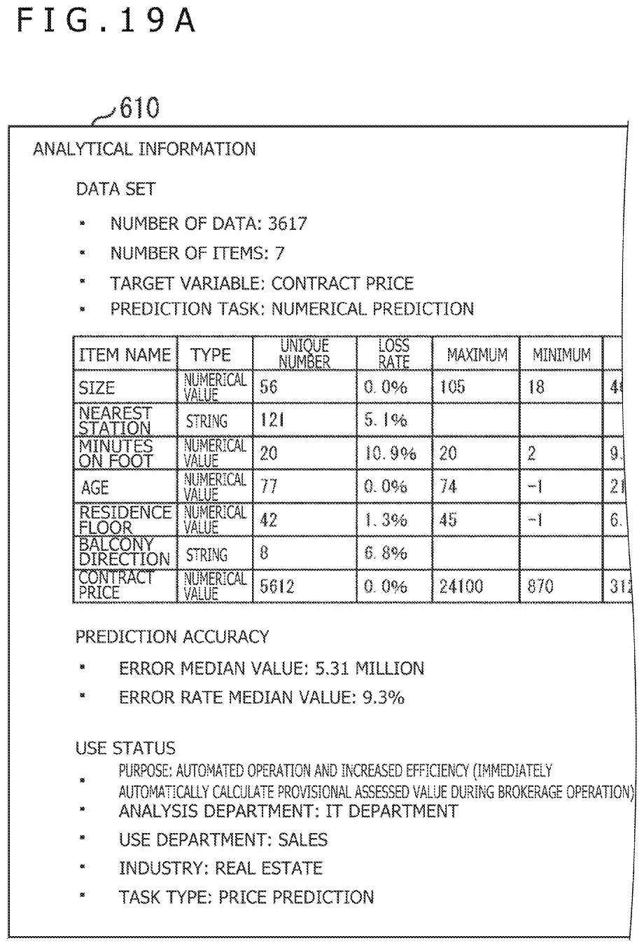

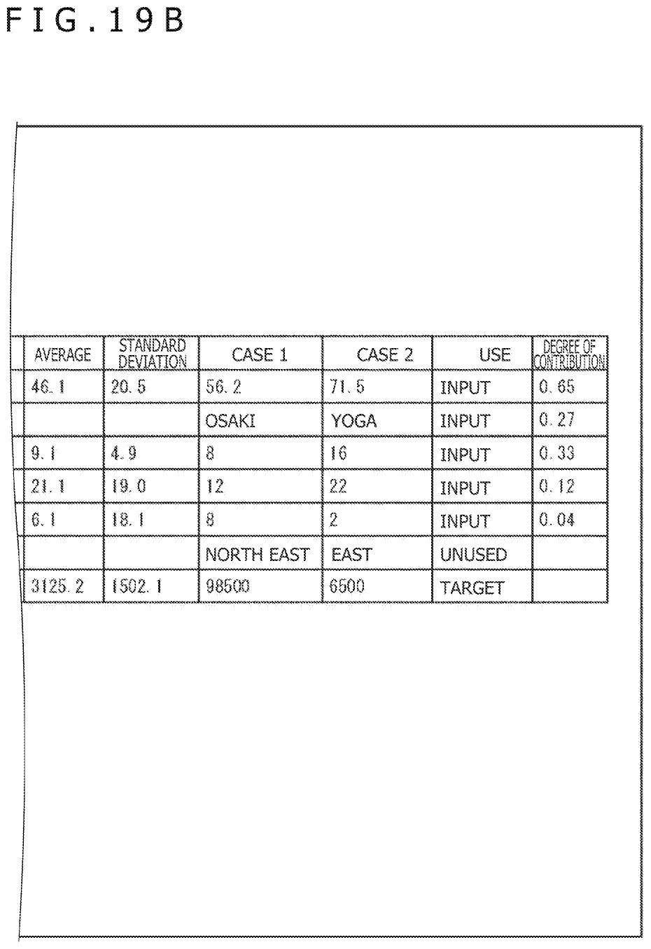

FIG. 19 is a diagram illustrating an example of the analysis information transmitted to the handbook creation apparatus 500.

Analysis information 610 in FIG. 19 includes item names in the data set, cases of data, the statistics of the data set, information obtained when the prediction analysis is applied to the data set (evaluation results), and the usage status of the prediction analysis.

In the example in FIG. 19, the item names (feature amounts) in the data set include the “size,” “nearest station,” “minutes on foot,” “age,” “residence floor,” “balcony direction,” and “contract price” for previously used condominiums as is the case with the above-described embodiment.

The cases of data are not actual data but are used to specifically understand the data set. The cases of data include, for example, data randomly selected for each item of the data set. In the example in FIG. 19, two cases of data (case 1 and case 2) are illustrated.

Note that, in case 1, the contract price is 985 million but that this is an erroneous input by the user U and that the original contracts price is 98.5 million. Such data is to be modified in step S112 of the flowchart in FIG. 18.

In addition to the number of data (in the example in FIG. 19, 3617) and the number of items (in the example in FIG. 19, 7), the statistics of the data set include the type of each item, the unique number, the loss rate, and the maximum value, the minimum value, the average value, and the standard deviation of the data. The statistics of the data set may include the median value and variance of data of each item.

The information obtained when the prediction analysis is applied to the data set includes a target variable, a prediction task (regression, binary classification, multinomial classification, or the like), an item list used, a prediction accuracy value, the statistic of the degree of contribution to prediction, and the like. In the example in FIG. 19, the target variable is the contract price, and the prediction task is numerical prediction. Additionally, the example in FIG. 19 indicates, as the prediction accuracy value, an error median value of 5.31 million and an error rate median value of 9.3% for the contract price used as the target variable. Note that, as the item list used, the settings resulting in the highest prediction accuracy are selected.

The usage status of the prediction analysis includes the purpose of the prediction analysis (automated operation and improved efficiency, marketing, predictor management, demand prediction, and the like), the analysis department having performed the prediction accuracy (data analysis department, sales department, marketing department, or the like), and the use department using the evaluation results (sales department, call center, personal department, or the like). Additionally, the usage status of the prediction analysis includes the business field of the company having performed the prediction analysis and a task type corresponding to a subcategory of the prediction task. In the example in FIG. 19, the purpose of the prediction analysis is “automated operation and improved efficiency” for immediate calculation of a provisional assessed value during a brokerage operation. Additionally, the analysis department is an IT department, the use department is the sales department, the business field is real estate, and the task type is price prediction.

The analysis information 610 as described above is transmitted to the handbook creation apparatus 500 and stored in the storage section 530.

### 9. Analysis Information Registration Processing

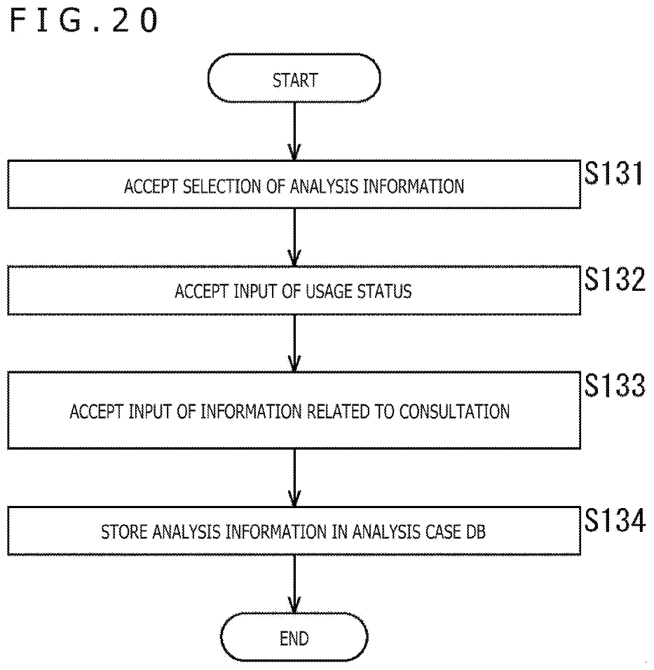

Now, with reference to a flowchart in FIG. 20, processing for registering analysis information in the analysis case DB 501 will be described, the processing being executed by the handbook creation apparatus 500.

In step S131, the control section 540 accepts a selection of analysis information from the analysis information stored in the storage section 530, according to a selection operation by the consultant C selecting analysis information to be registered in the analysis case DB 501.

In step S132, the control section 540 accepts the input of the usage status of the prediction analysis according to an input operation by the consultant C. The input usage status of the prediction analysis is added to the selected analysis information. This processing is executed as needed and may be performed in the prediction analysis tool 400 as described above.

In step S133, the control section 540 accepts the input of information related to consultation according to the input operation by the consultant C. Information related to consultation (input information) is, for example, text information representing evaluation by the consultant C and the results of examination by the consultant C, for the prediction analysis by which the selected analysis information has been obtained.

In step S134, according to a registration operation by the consultant C, the control section 540 stores the selected analysis information in the analysis case DB 501 in association with the input information (text information).

The analysis information registration processing is executed as described above.

### Example of Analysis Information

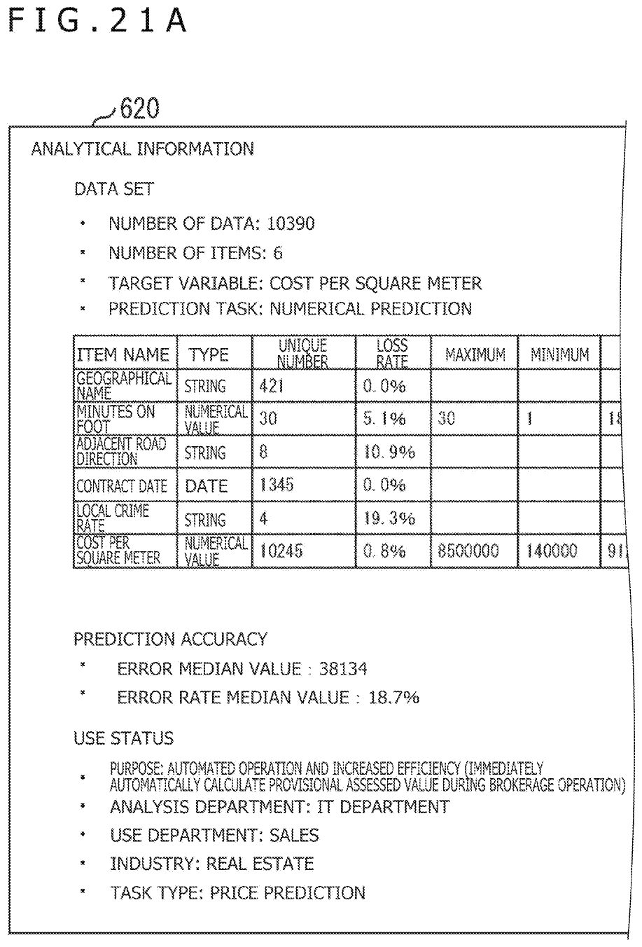

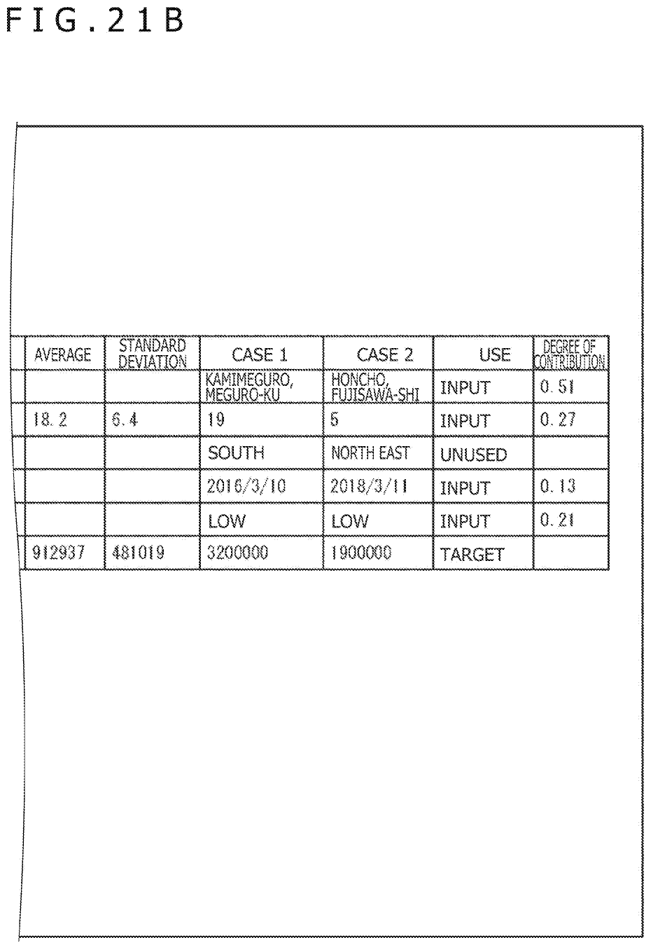

FIG. 21 is a diagram illustrating an example of analysis information registered in the analysis case DB 501.

A configuration of analysis information 620 in FIG. 21 is basically similar to the configuration of the analysis information 610 in FIG. 19.

In an example in FIG. 21, the number of data is 10390, the number of items is 6, the target variable is cost per square meter, and the prediction task is numerical prediction.

Additionally, in the example in FIG. 21, the item names (feature amounts) in the data set include “geographical name,” “minutes on foot,” “adjacent road direction,” “contract date,” “local crime rate,” and “cost per square meter” for previously used condominiums.

Furthermore, the example in FIG. 21 indicates, as the prediction accuracy value, an error median value of 38134 and an error rate median value of 18.7% for the cost per square meter.

In the example in FIG. 21, the purpose of the prediction analysis is “automated operation and improved efficiency” for immediate calculation of the provisional assessed value during the brokerage operation. The analysis department is the IT department, the use department is the sales department, the business field is real estate, and the task type is price prediction.

### Example of Input Information

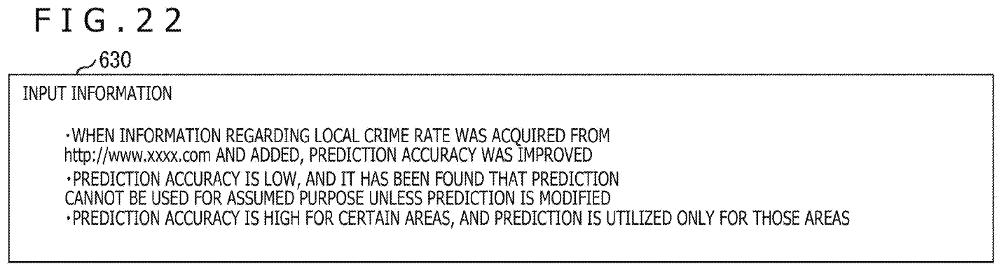

FIG. 22 is a diagram illustrating an example of input information registered in the analysis case DB 501 in association with the analysis information 620 in FIG. 21.

Input information 630 in FIG. 22 includes text information input for the analysis information 620 by the consultant C.

Specifically, the input information 630 includes, for the prediction analysis by which the analysis information 620 has been obtained, text information regarding three factors:

The prediction accuracy has been improved by acquiring information regarding the local crime rate from a specific URL and adding the information.

The prediction accuracy is low, and the prediction analysis presently fails to be used for the assumed purpose.

In view of the above-described factors, the prediction analysis can be used for areas with high prediction accuracy.

The input information 630 as described above is registered in the analysis case DB 501 in association with the analysis information 620.

### 10. Handbook Presentation Processing

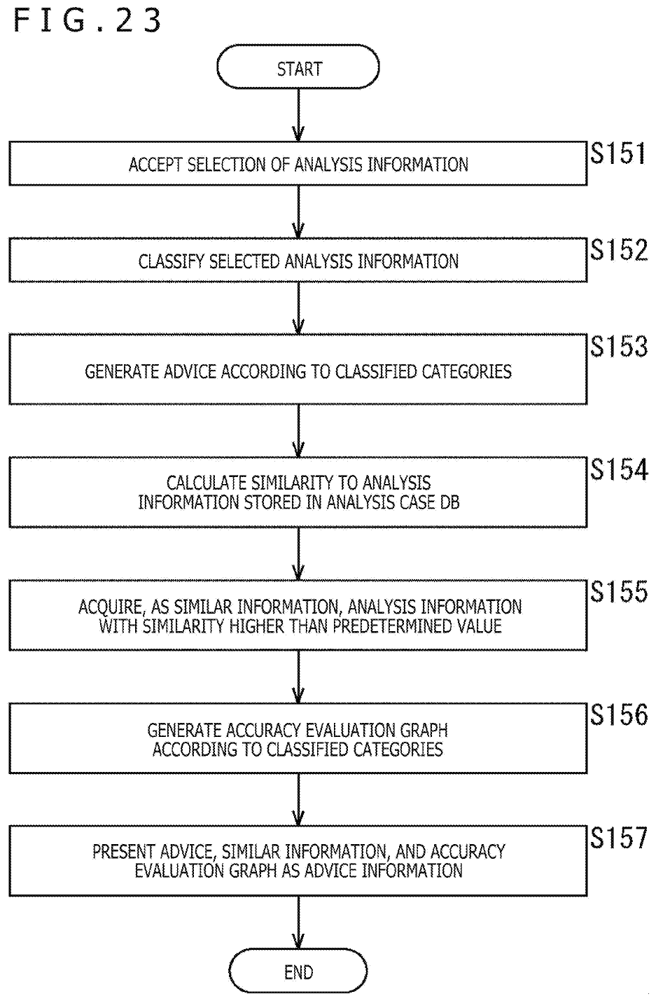

Now, with reference to a flowchart in FIG. 23, handbook presentation processing by the handbook creation apparatus 500 will be described.

In step S151, according to an operation of selecting consultation target analysis information by the consultant C, the control section 540 accepts a selection of analysis information from the analysis information stored in the storage section 530. In this example, it is assumed that the analysis information 610 in FIG. 19 is selected.

In step S152, on the basis of the contents of the analysis information selected by the consultant C, the control section 540 of the handbook creation apparatus 500 classifies the analysis information.

In step S153, according to a category into which the consultation target analysis information is classified, the advice generation section 551 of the control section 540 generates advice related to the prediction analysis by which the analysis information has been obtained.

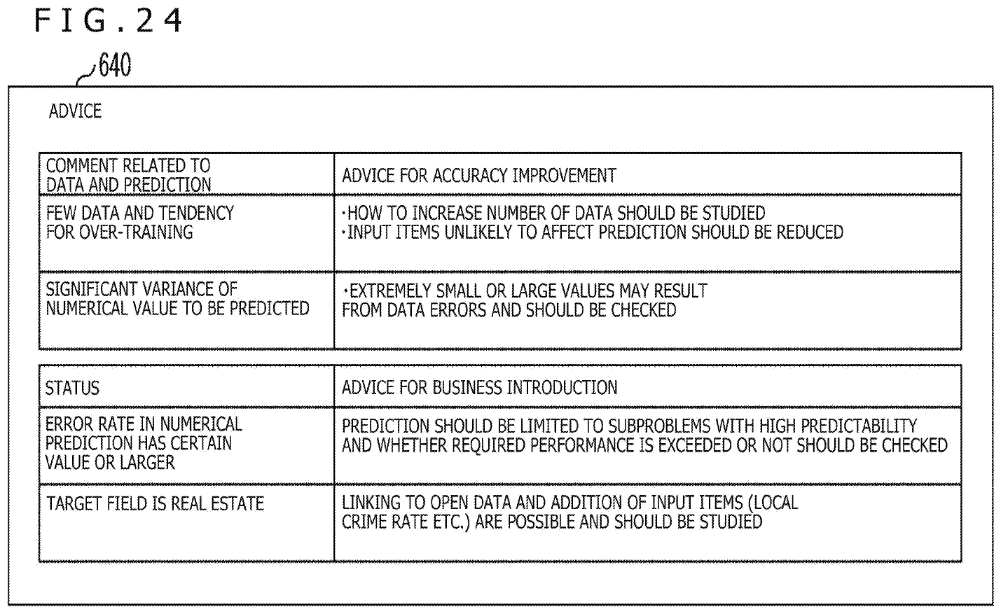

FIG. 24 is a diagram illustrating an example of advice generated by the advice generation section 551.

In advice 640 in FIG. 24, the consultation target analysis information is classified in terms of “comment related to data and prediction” and “status,” and advice for accuracy improvement and advice for business introduction are generated for each analysis result.

Specifically, the consultation target analysis information is classified, in terms of the comment related to data and prediction, as “few data and tendency for over-training,” and “significant variance of the numerical value to be predicted.”

For “few data and tendency for over-training,” advice for accuracy improvement is generated indicating that “how to increase the number of data should be studied,” and that “input items (feature amounts) unlikely to affect prediction should be reduced.” Additionally, for “significant variance of the numerical value to be predicted,” advice for accuracy improvement is generated indicating that “extremely small or large values may result from data errors and should thus be checked.”

Additionally, the consultation target analysis information is classified, in terms of the status, as “the error rate in numerical prediction having a certain value or larger” and “the target field being real estate.”

For “the error rate in numerical prediction having a certain value or larger,” advice for business introduction is generated indicating that “the prediction should be limited to subproblems with high predictability and whether required performance is exceeded or not should be checked.” Additionally, for “the target field being real estate,” advice for business introduction is generated indicating that “linking to open data and addition of input items (local crime rate and the like) are possible and should be studied.”

The pieces of advice constituting the advice 640 described above are stored in the storage section 530 on a category-by-category basis. The advice generation section 551 can generate the advice 640 by reading the optimum advice from the storage section 530 in accordance with a rule base corresponding to the category into which the analysis information is classified. In other words, the consultation target analysis information functions as a query for extracting the advice.

Note that the advice generation section 551 may generate the advice 640 through machine learning corresponding to the category into which the analysis information is classified, rather than in accordance with the rule base corresponding to the category.

Referring back to the flowchart in FIG. 23, in step S154, the similar-information acquisition section 552 calculates the similarity between the consultation target analysis information and the analysis information stored in the analysis case DB 501.

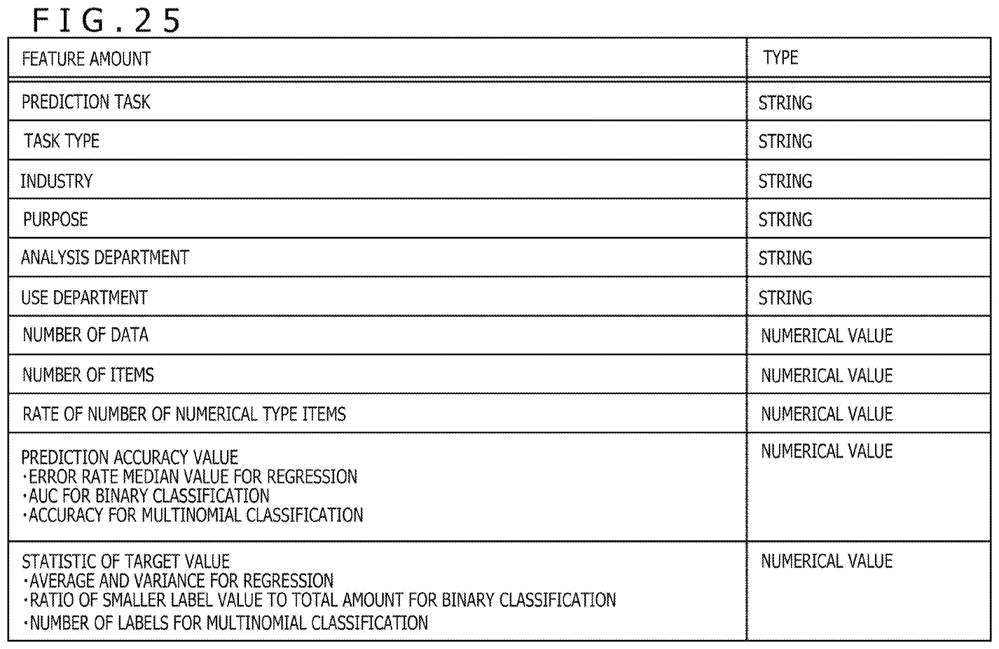

For example, the similar-information acquisition section 552 calculates, for the two pieces of analysis information, the distance for each of the feature amounts illustrated in FIG. 25, and determines the weighted sum of the calculated distances to be the distance between the two pieces of analysis information. The similar-information acquisition section 552 calculates the distance between each of the plurality of pieces of analysis information stored in the analysis case DB 501 and the consultation target analysis information, and expresses each calculated distance in a monotonically decreasing function to obtain similarity.

In calculation of the distance for each feature amount illustrated in FIG. 25, for numerical type feature amounts (the number of data, the number of items, the rate of the number of the numerical type items, the prediction accuracy value, and the statistic of the target value), the distance is calculated as a numerical value. Note that the prediction accuracy value is an error median value in a case where the prediction task is regression, AUC in a case where the prediction task is binary classification, and accuracy (correct rate) in a case where the prediction task is multinomial classification. Additionally, the statistic of the target value is average and variance in a case where the prediction task is regression, the ratio of smaller label value to the total amount in a case where the prediction task is binary classification, and the number of labels in a case where the prediction task is multinomial classification.

On the other hand, in calculation of the distance for each feature amount, for string type feature amounts (the prediction type, the task type, the business field, the purpose, the analysis department, and the use department), the distance is calculated by defining matched feature amounts as 1, while defining mismatched feature amounts as 0.

Referring back to the flowchart in FIG. 23, in step S155, the similar-information acquisition section 552 acquires analysis information with the calculated similarity (each distance in monotonically decreasing function) being higher than a predetermined value, from the analysis case DB 501 as similar information. In this example, it is assumed that, as similar information, the analysis information 620 in FIG. 21 and the input information in FIG. 22 associated with the analysis information 620 are acquired.

In step S156, according to the category into which the consultation target analysis information is classified, the graph generation section 553 generates an accuracy evaluation graph used to evaluate the prediction accuracy of the prediction analysis by which the analysis information has been obtained.

At this time, the graph generation section 553 generates an accuracy evaluation graph corresponding to the information input by the consultant C (the purpose of the prediction accuracy and the like), for example.

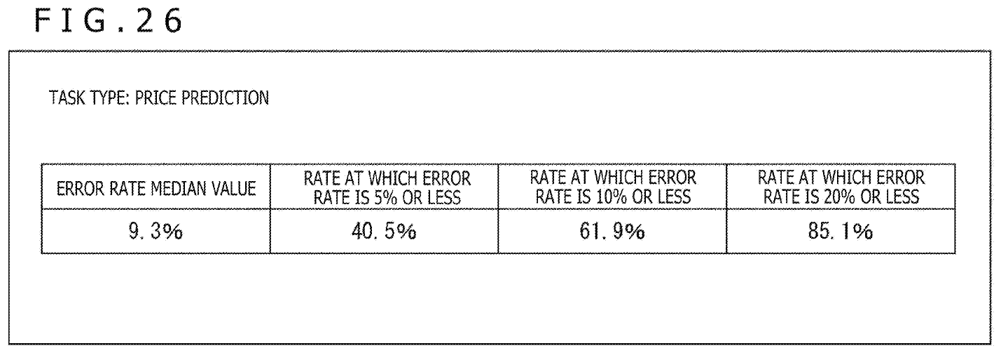

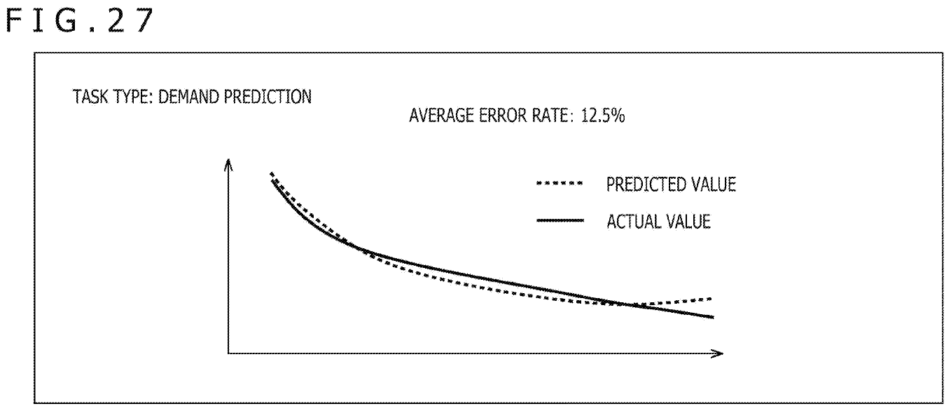

Here, with reference to FIG. 26 and FIG. 27, the accuracy evaluation graph generated by the graph generation section 553 will be described.

FIG. 26 is a diagram illustrating an example of an accuracy evaluation graph generated in a case where the “price prediction” is input by the consultant C as a task type.

The accuracy evaluation graph in FIG. 26 indicates, with respect to an error rate median value of 9.3% included in the analysis information 610 in FIG. 19, the rates at which the rate of error in the contract price, used as the target variable of the analysis information 610, is 5% or less, 10% or less, and 20% or less. In an example in FIG. 26, the rate at which the error rate is 5% or less is 40.5%, the rate at which the error rate is 10% or less is 61.9%, and the rate at which the error rate is 20% or less is 85.1%.

FIG. 27 is a diagram illustrating an example of an accuracy evaluation graph generated in a case where “demand prediction” is input by the consultant C as the task type.

The accuracy evaluation graph in FIG. 27 depicts a graph of the prediction value and a graph of the actual value for the demand prediction for a predetermined period. In the example in FIG. 27, the prediction value is illustrated as a dotted line, the actual value is illustrated as a solid line, and the average error rate is 12.5%.

Note that, in the example in FIG. 27, after inputting the demand prediction as the task type, the consultant C inputs time information corresponding to the predetermined period. In such a manner, depending on the task type, the input of additional information by the consultant C can be accepted.

In the above-described example, the task type is input by the consultant C. However, for example, the task type may be automatically determined from a string of the prediction task and a string of the target variable. For example, in a case where the prediction task is the numerical prediction and the target variable is the cost per square meter, the task type is determined to be the price prediction.

The accuracy evaluation graph as described above is also stored in the storage section 530 on a category-by-category basis. The graph generation section 553 can generate an accuracy evaluation graph by reading the optimum accuracy evaluation graph from the storage section 530 in accordance with the rule base corresponding to the category into which the analysis information is classified. In other words, the consultation target analysis information functions as a query for extracting the accuracy evaluation graph.

Referring back to the flowchart in FIG. 23, in step S157, the presentation control section 554 controls the presentation, to the presentation section 520 as the advice information, of the advice generated by the advice generation section 551, the similar information acquired by the similar-information acquisition section 552, and the accuracy evaluation graph generated by the graph generation section 553.

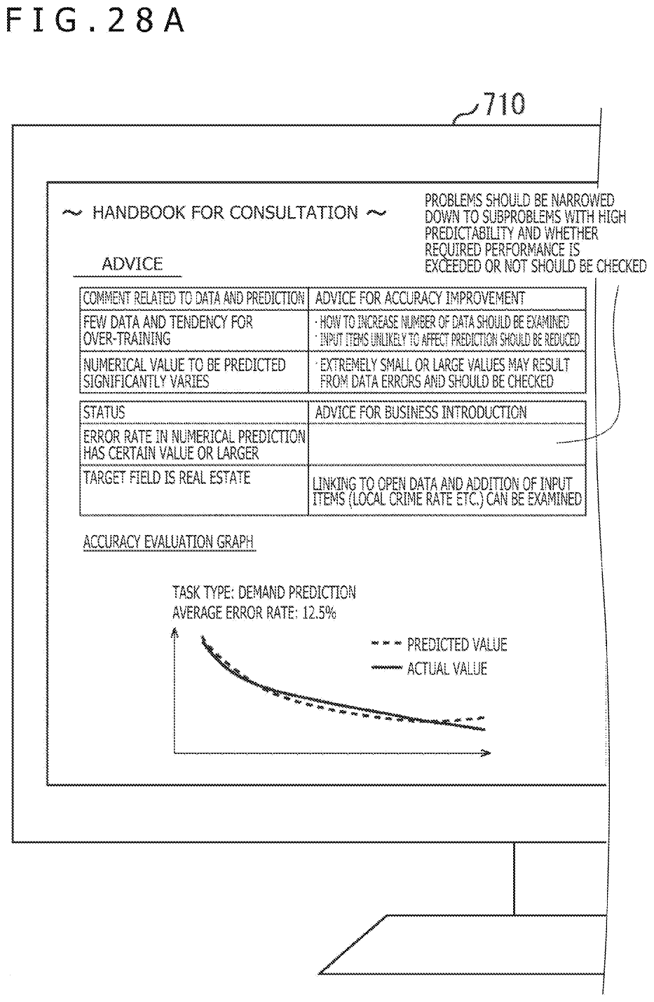

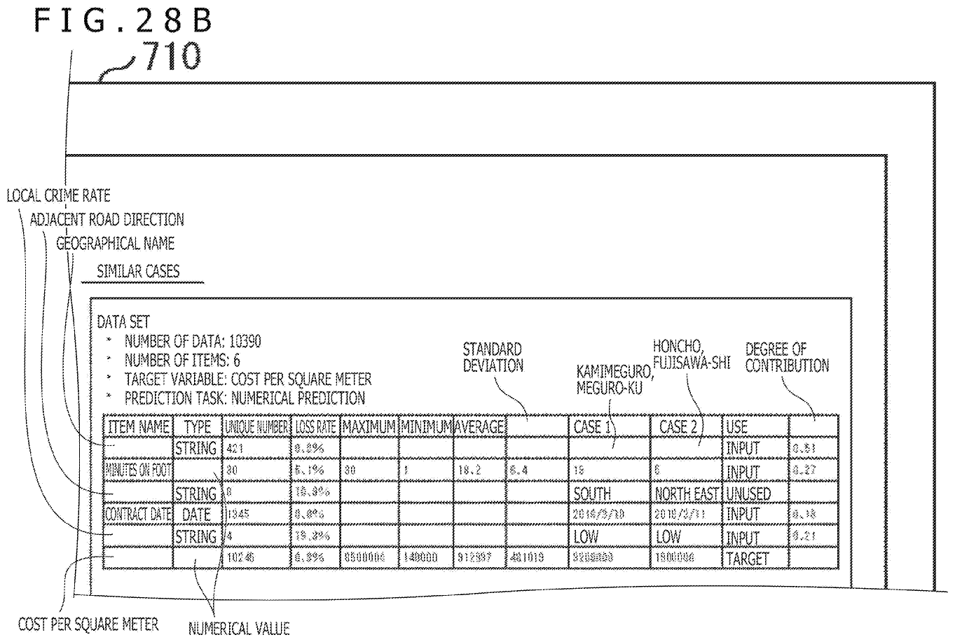

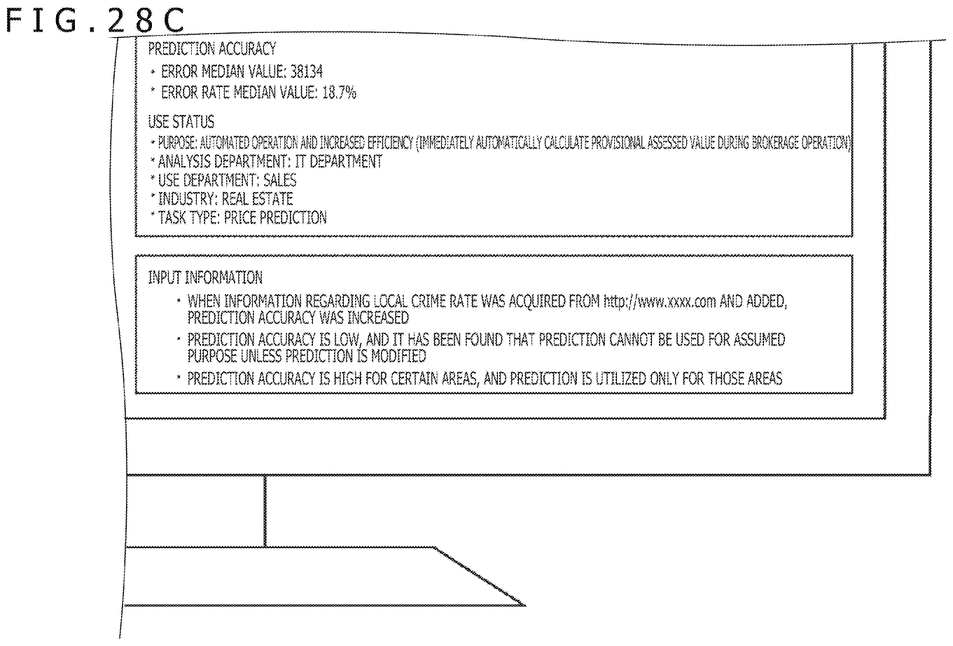

FIG. 28 is a diagram illustrating an example of presentation of the advice information in a case where the presentation section 520 is configured as a monitor.

A screen of a monitor 710 illustrated in FIG. 28 displays a consulting handbook including the advice 640 in FIG. 24, the analysis information in FIG. 21 and the input information in FIG. 22 as similar cases, and the accuracy evaluation graph in FIG. 27.

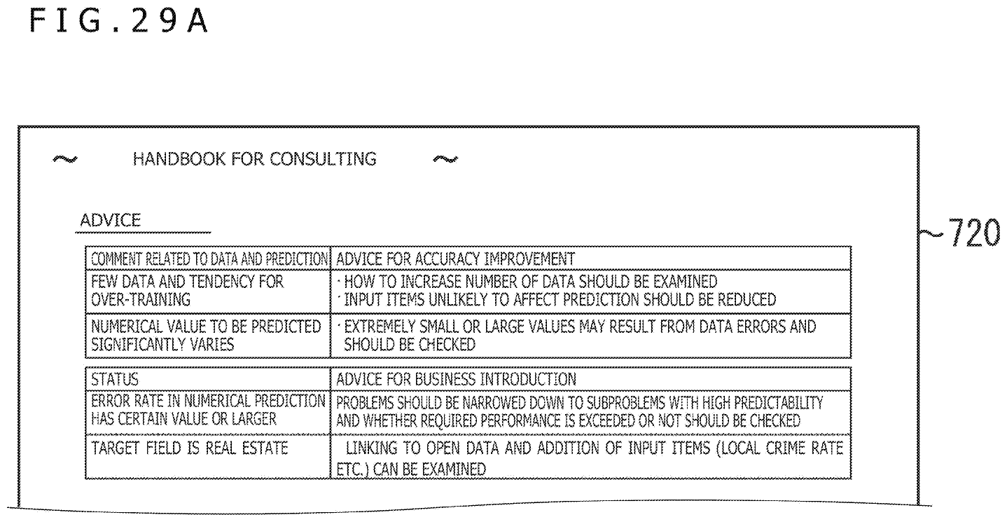

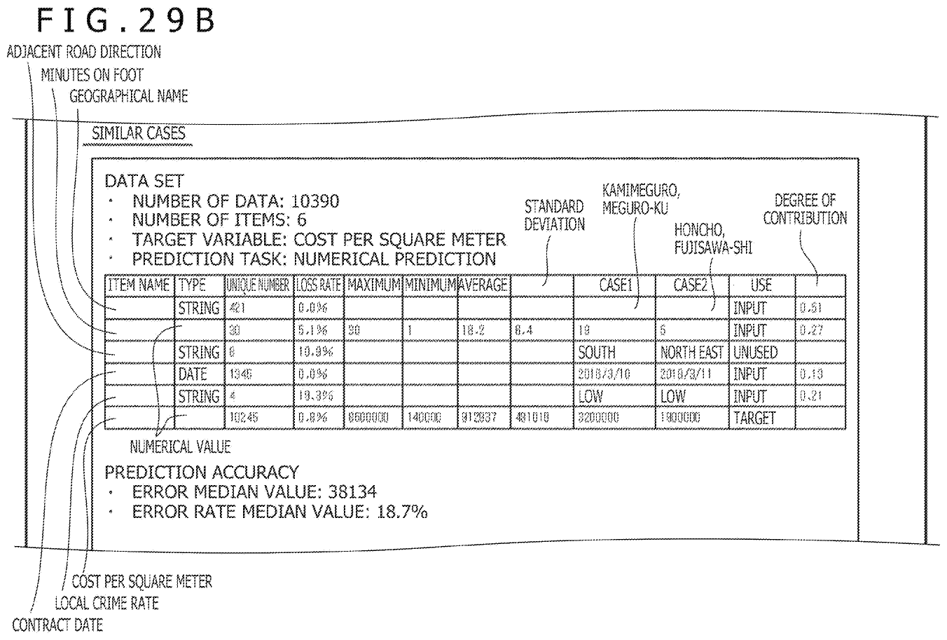

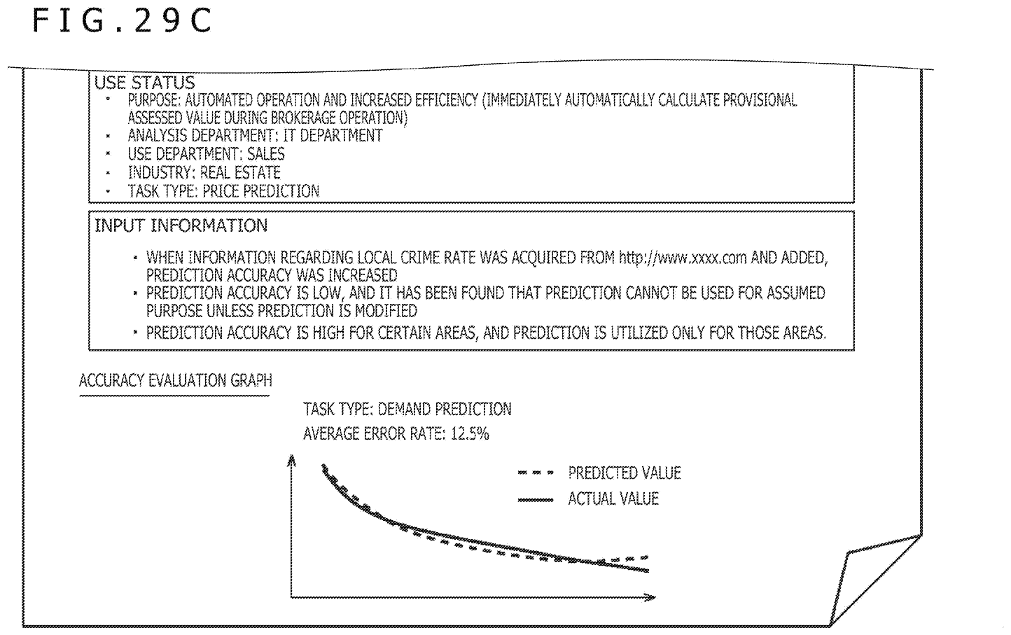

FIG. 29 is a diagram illustrating an example of presentation of the advice information in a case where the presentation section 520 is configured as a printer.

A print medium 720 illustrated in FIG. 29 and output by the presentation section 520 used as a printer indicates the consulting handbook printed on the print medium 720 and including the advice 640 in FIG. 24, the analysis information in FIG. 21 and the input information in FIG. 22 as similar cases, and the accuracy evaluation graph in FIG. 27.

On the basis of the contents (advice information) of the handbook thus presented, the consultant C can provide consultation on the prediction analysis performed by the user U (prediction analysis by which the analysis information 610 in FIG. 19 has been obtained).

The above-described processing allows the consultant side to share knowledge and support the whole effort to introduce the prediction analysis, on the basis of the contents of the presented handbook, enabling the quality of the consultation to be improved.

### 11. Hardware Configuration of Computer

Now, a hardware configuration of the information processing apparatus according to the embodiment of the present disclosure will be described.

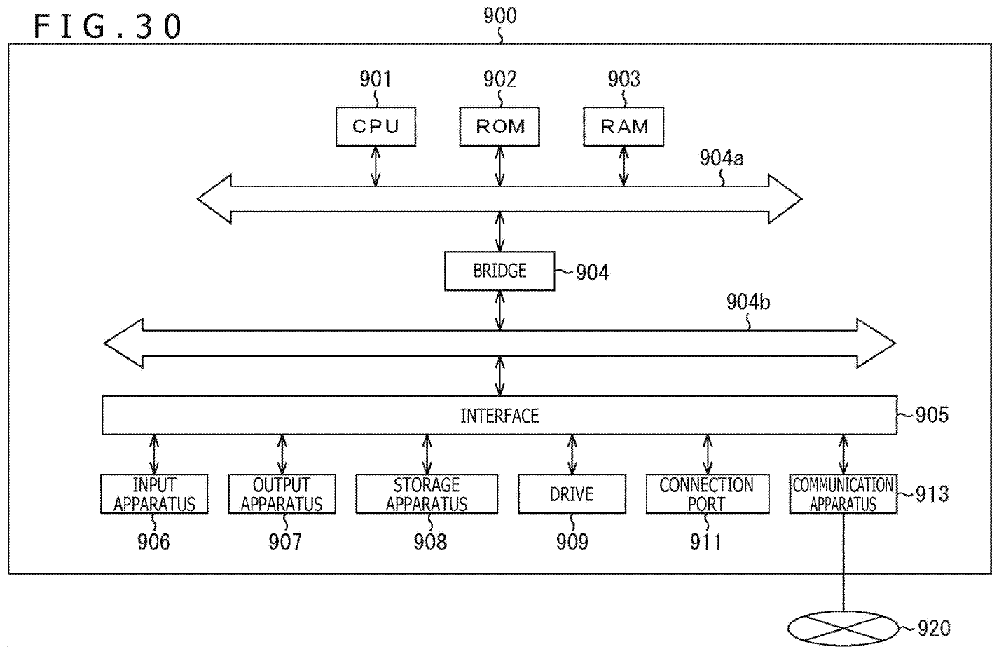

FIG. 30 is a block diagram illustrating a hardware configuration example of the information processing apparatus according to the embodiment of the present disclosure.

A computer 900 illustrated in FIG. 30 may implement, for example, the information processing apparatus 100 or the handbook creation apparatus 500 according to the above-described embodiment.

The computer 900 includes a CPU (Central Processing Unit) 901, a ROM (Read Only Memory) 903, and a RAM (Random Access Memory) 905. Additionally, the computer 900 may include a host bus 907, a bridge 909, an external bus 911, an interface 913, an input apparatus 915, an output apparatus 917, a storage apparatus 919, a drive 921, a connection port 923, and a communication apparatus 925. Instead of or in addition to the CPU 901, the computer 900 may include a processing circuit such as a DSP (Digital Signal Processor), an ASIC (Application Specific Integrated Circuit), or an FPGA (Field-Programmable Gate Array).

The CPU 901 functions as a computation processing apparatus and a control apparatus, and controls the overall operation or a part of the operation in the computer 900 in accordance with various programs recorded in the ROM 903, the RAM 905, the storage apparatus 919, or a removable recording medium 927. The ROM 903 stores programs, computation parameters, and the like used by the CPU 901. The RAM 905 primarily stores programs used in execution by the CPU 901, parameters varying as appropriate in the execution, and the like. The CPU 901, the ROM 903, and the RAM 905 are connected together by a host bus 907 including an internal bus such as a CPU bus. Furthermore, the host bus 907 is connected to the external bus 911 such as a PCI (Peripheral Component Interconnect/Interface) bus via the bridge 909.

The input apparatus 915 is an apparatus operated by the user and including, for example, a mouse, a keyboard, a touch panel, buttons, switches, and a lever. The input apparatus 915 may be, for example, a remote control apparatus utilizing infrared rays or other radio waves or an external connection equipment 929 such as a cellular phone which enables operation of the computer 900. The input apparatus 915 includes an input control circuit generating an input signal, on the basis of information input by the user and outputting the input signal to the CPU 901. The user operates the input apparatus 915 to input various kinds of data to the computer 900 and to indicate processing operations to the computer 900.

The output apparatus 917 includes an apparatus that can notify the user of acquired information using a sense such as a visual sense, an acoustic sense, or a haptic sense. The output apparatus 917 may be, for example, a display apparatus such as an LCD (Liquid Crystal Display) or an organic EL (Electro-Luminescence) display, a sound output apparatus such as a speaker or a headphone, or a vibrator. The output apparatus 917 outputs results obtained by processing by the computer 900 as a video such as a text or an image, voice such as voice or sound, or vibration, or the like.

The storage apparatus 919 is an apparatus for data storage configured as an example of the storage section of the computer 900. The storage apparatus 919 includes, for example, a magnetic storage device such as an HDD (Hard Disk Drive), a semiconductor storage device, an optical storage device, a magneto-optic storage device, or the like. The storage apparatus 919 stores, for example, programs and various kinds of data executed by the CPU 901, various kinds of data externally acquired, and the like.

The drive 921 is a reader/writer for the removable recording medium 927 such as a magnetic disk, an optical disc, a magneto-optic disc, or a semiconductor memory and is built into the computer 900 or installed external to the computer 900. The drive 921 reads information recorded in the installed removable recording medium 927 and outputs the information to the RAM 905. Additionally, the drive 921 writes recording to the installed removable recording medium 927.

The connection port 923 is a port used to connect equipment to the computer 900. The connection port 923 may be, for example, a USB (Universal Serial Bus) port, an IEEE 1394 port, an SCSI (Small Computer System Interface) port, or the like. Alternatively, the connection port 923 may be an RS-232C port, an optical audio terminal, an HDMI (registered trademark) (High-Definition Multimedia Interface) port, or the like. When external connection equipment 929 is connected to the connection port 923, various kinds of data may be exchanged between the computer 900 and the external connection equipment 929.

The communication apparatus 925 is, for example, a communication interface including, for example, a communication device for connection to a communication network 931. The communication apparatus 925 may be, for example, a communication card for a LAN (Local Area Network), Bluetooth (registered trademark), Wi-Fi, WUSB (Wireless USB), or the like. Alternatively, the communication apparatus 925 may be a router for optical communication, a router for ADSL (Asymmetric Digital Subscriber Line), a modem for any of various kinds of communication, or the like. The communication apparatus 925 transmits and receives signals and the like to and from the Internet and any other communication equipment using a predetermined protocol such as TCP/IP. Additionally, the communication network 931 connected to the communication apparatus 925 is a network connected by wire or wirelessly and may include, for example, the Internet, a home LAN, infrared communication, radio wave communication, satellite communication, and the like.

An example of hardware configuration of the computer 900 has been illustrated above. The above-described components may be configured using general-purpose members or hardware specialized for the function of each component. Such a configuration may be changed as appropriate according to the current level of the implemented technique.

Note that the program executed by the computer 900 may be a program in which processing is chronologically executed along the order described herein or executed in parallel or at required timings such as for invocations.

Note that the embodiment of the technique according to the present disclosure is not limited to the above-described embodiment and that various changes may be made to the embodiment without departing from the spirits of the technique according to the present disclosure.

Additionally, the effects described herein are only illustrative and not restrictive, and other effects may be produced.

Furthermore, the technique according to the present disclosure can take the following configuration.

(1)

An information processing apparatus including:

a prediction analysis section that calculates an evaluation value for an evaluation data set used to evaluate a prediction model, for a predetermined number of data samples in a learning data set used for training of the prediction model; and

an advice generation section that generates, on the basis of the evaluation value for all the data samples in the learning data set and gradients of the data samples, presentation information for presenting advice related to at least one of the data samples in the learning data set or feature amounts of the data samples.

(2)

The information processing apparatus according to (1), in which

on the basis of a magnitude relationship between the evaluation value for all the data samples in the learning data set and a predetermined threshold, the advice generation section generates the presentation information for presenting the advice for improvement of the number of feature amounts in the learning data set.

(3)

The information processing apparatus according to (2), in which

in a case where the evaluation value for all the data samples in the learning data set is smaller than the threshold, the advice generation section generates the presentation information for presenting the advice indicating that the number of the feature amounts in the learning data set is insufficient.

(4)

The information processing apparatus according to (2) or (3), in which

in a case where the evaluation value for all the data samples in the learning data set is larger than the threshold, the advice generation section generates the presentation information for presenting the advice indicating that the feature amounts in the learning data set are sufficient.

(5)

The information processing apparatus according to (1), in which

on the basis of a magnitude relationship between the gradient of the evaluation value for all the data samples in the learning data set and a predetermined threshold, the advice generation section generates the presentation information for presenting the advice for improvement of the number of data samples in the learning data set.

(6)

The information processing apparatus according to (5), in which

in a case where the gradient of the evaluation value for all the data samples in the learning data set is larger than the threshold, the advice generation section generates the presentation information for presenting the advice indicating that the number of the data samples in the learning data set is insufficient.

(7)

The information processing apparatus according to (5) or (6), in which

in a case where the gradient of the evaluation value for all the data samples in the learning data set is smaller than the threshold, the advice generation section generates the presentation information for presenting the advice indicating that the number of the data samples in the learning data set is sufficient.

(8)

The information processing apparatus according to any one of (5) to (7), in which

the gradient is a difference between the evaluation value for all the data samples in the learning data set and the evaluation value for data samples larger or smaller in number than all the data samples.

(9)

The information processing apparatus according to any one of (5) to (7), in which

the threshold is determined on the basis of the evaluation value for all the data samples in the learning data set.

(10)

The information processing apparatus according to any one of (5) to (7), in which

the gradient is a rate of increase in difference between a first evaluation value for the learning data set and a second evaluation value for the evaluation data set with respect to the number of times of parameter updates for the prediction model in a learning algorithm.

The information processing apparatus according to any one of (1) to (10), in which

the prediction analysis section trains an error prediction model estimating a prediction error in the prediction model, and

on the basis of a degree of contribution of the feature amount to the prediction error calculated using the error prediction model, the advice generation section generates the presentation information for presenting the advice related to a first feature amount contributing to an increase in the prediction error.

(12)

The information processing apparatus according to (11), in which

the presentation information includes a value of the first feature amount.

(13)

The information processing apparatus according to (11) or (12), in which

the presentation information includes the data sample with a value of the first feature amount.

(14)

The information processing apparatus according to any one of (11) to (13), in which

the presentation information includes a second feature amount having a larger contribution to prediction by the prediction model, in the data sample having the value of the first feature amount.

(15)

The information processing apparatus according to any one of (11) to (14), in which

the presentation information includes a first data sample and a second data sample included in a plurality of the data samples having the value of the first feature amount, the first and second data samples having a higher similarity in the feature amount and having positive and negative prediction errors.

(16)

The information processing apparatus according to any one of (11) to (15), in which

the presentation information includes an amount by which an average error in the data samples having the value of the first feature amount is larger than the average error in all the data samples.

(17)

The information processing apparatus according to any one of (11) to (16), in which

the presentation information includes a ratio of the data samples having the value of the first feature amount to all the data samples.

(18)

The information processing apparatus according to any one of (11) to (17), in which

the presentation information related to the first feature amount includes the feature amount for which a correlation value representing a correlation with the first feature amount is smaller.

(19)

An information processing method comprising:

calculating, by an information processing apparatus, an evaluation value for an evaluation data set used to evaluate a prediction model, for a predetermined number of data samples in a learning data set used for training of the prediction model; and

by the information processing apparatus, on the basis of the evaluation value for all the data samples in the learning data set and gradients of the data samples, generating presentation information for presenting advice related to at least one of the data samples in the learning data set or feature amounts of the data samples.

(20)

A program causing a computer to execute processing of: calculating an evaluation value for an evaluation data set used to evaluate a prediction model, for a predetermined number of data samples in a learning data set used for training of the prediction model; and

on the basis of the evaluation value for all the data samples in the learning data set and gradients of the data samples, generating presentation information for presenting advice related to at least one of the data samples in the learning data set or feature amounts of the data samples.

Additionally, the technique according to the present disclosure can also take the following configuration.

(1)

An information processing apparatus including:

a control section controlling presentation of advice information regarding consultation for the prediction analysis on the basis of a content of analysis information obtained by prediction analysis.

(2)

The information processing apparatus according to (1), further including:

an advice generation section that generates advice related to the prediction analysis, in which

the control section presents the advice as the advice information.

(3)

The information processing apparatus according to (2), in which

the advice generation section generates the advice according to a category into which the analysis information is classified on the basis of the content of the analysis information.

(4)

The information processing apparatus according to (3), in which

the advice generation section generates the advice in accordance with a rule base corresponding to the category into which the analysis information is classified.

(5)

The information processing apparatus according to (3), in which

the advice generation section generates the advice through machine learning corresponding to the category into which the analysis information is classified.

(6)

The information processing apparatus according to any one of (1) to (5), in which

the analysis information includes a statistic of a data set.

(7)

The information processing apparatus according to any one of (1) to (5), in which

the analysis information includes an evaluation result for the prediction analysis.

(8)

The information processing apparatus according to (7), in which

the evaluation result for the prediction analysis includes at least one of prediction accuracy of the prediction analysis or a degree of contribution of the data set.

(9)

The information processing apparatus according to any one of (1) to (8), in which

the analysis information includes a usage status of the prediction analysis.

(10)

The information processing apparatus according to (9), in which

the usage status of the prediction analysis includes at least a purpose of the prediction analysis.

(11)

The information processing apparatus according to (9), in which

the usage status of the prediction analysis is information input by a user receiving consultation or a consultant providing the consultation.

(12)

The information processing apparatus according to (2), further including:

a similar-information acquisition section acquiring, from the analysis information obtained in the past, similar information having a similarity higher than a predetermined value to the consultation target analysis information, in which

the control section further presents the similar information acquired, as the advice information.

(13)

The information processing apparatus according to (12), in which

the control section presents, along with the similar information, text information input for the similar information by the consultant providing the consultation.

(14)

The information processing apparatus according to (2), further including:

a graph generation section that generates an accuracy evaluation graph used to evaluate prediction accuracy of the prediction analysis, in which

the control section further presents the accuracy evaluation graph as the advice information.

(15)

The information processing apparatus according to (14), in which

the graph generation section generates the accuracy evaluation graph according to a category into which the analysis information is classified, on the basis of the content of the analysis information.

(16)

The information processing apparatus according to (15), in which

the graph generation section generates the accuracy evaluation graph in accordance with a rule base corresponding to the category into which the analysis information is classified.

(17)

The information processing apparatus according to (1), in which

the control section controls display of the advice information on a screen.

(18)

The information processing apparatus according to (1), in which

the control section controls printing of the advice information on a print medium.

(19)

An information processing method including:

controlling presentation of advice information regarding consultation for the prediction analysis on the basis of a content of analysis information obtained by prediction analysis.

(20)

A program for causing a computer to execute processing for:

controlling presentation of advice information regarding consultation for the prediction analysis on the basis of a content of analysis information obtained by prediction analysis.

### REFERENCE SIGNS LIST

100 Information processing apparatus, 110 Input section, 120 Output section, 130 Storage section, 140 Control section, 151 Prediction analysis section, 152 Advice generation section, 400 Prediction analysis tool, 500 Handbook creation apparatus, 501 Analysis case DB, 510 Input section, 520 Presentation section, 530 Storage section, 540 Control section, 551 Advice generation section, 552 Similar-information acquisition section, 553 Graph generation section, 554 Presentation control section, 900 Computer

1. An information processing apparatus comprising:
a prediction analysis section that calculates an evaluation value for an evaluation data set used to evaluate a prediction model, for a predetermined number of data samples in a learning data set used for training of the prediction model; and
an advice generation section that generates, on a basis of the evaluation value for all the data samples in the learning data set and gradients of the data samples, presentation information for presenting advice related to at least one of the data samples in the learning data set or feature amounts of the data samples.

2. The information processing apparatus according to claim 1, wherein
on a basis of a magnitude relationship between the evaluation value for all the data samples in the learning data set and a predetermined threshold, the advice generation section generates the presentation information for presenting the advice for improvement of the number of feature amounts in the learning data set.

3. The information processing apparatus according to claim 2, wherein
in a case where the evaluation value for all the data samples in the learning data set is smaller than the threshold, the advice generation section generates the presentation information for presenting the advice indicating that the number of the feature amounts in the learning data set is insufficient.

4. The information processing apparatus according to claim 2, wherein
in a case where the evaluation value for all the data samples in the learning data set is larger than the threshold, the advice generation section generates the presentation information for presenting the advice indicating that the feature amounts in the learning data set are sufficient.

5. The information processing apparatus according to claim 1, wherein
on a basis of a magnitude relationship between the gradient of the evaluation value for all the data samples in the learning data set and a predetermined threshold, the advice generation section generates the presentation information for presenting the advice for improvement of the number of data samples in the learning data set.

6. The information processing apparatus according to claim 5, wherein
in a case where the gradient of the evaluation value for all the data samples in the learning data set is larger than the threshold, the advice generation section generates the presentation information for presenting the advice indicating that the number of the data samples in the learning data set is insufficient.

7. The information processing apparatus according to 5, wherein
in a case where the gradient of the evaluation value for all the data samples in the learning data set is smaller than the threshold, the advice generation section generates the presentation information for presenting the advice indicating that the number of the data samples in the learning data set is sufficient.

8. The information processing apparatus according to claim 5, wherein
the gradient is a difference between the evaluation value for all the data samples in the learning data set and the evaluation value for data samples larger or smaller in number than all the data samples.

9. The information processing apparatus according to claim 5, wherein
the threshold is determined on a basis of the evaluation value for all the data samples in the learning data set.

10. The information processing apparatus according to claim 5, wherein
the gradient is a rate of increase in difference between a first evaluation value for the learning data set and a second evaluation value for the evaluation data set with respect to the number of times of parameter updates for the prediction model in a learning algorithm.

11. The information processing apparatus according to claim 1, wherein
the prediction analysis section trains an error prediction model estimating a prediction error in the prediction model, and
on a basis of a degree of contribution of the feature amount to the prediction error calculated using the error prediction model, the advice generation section generates the presentation information for presenting the advice related to a first feature amount contributing to an increase in the prediction error.

12. The information processing apparatus according to claim 11, wherein
the presentation information includes a value of the first feature amount.

13. The information processing apparatus according to claim 11, wherein
the presentation information includes the data sample with a value of the first feature amount.

14. The information processing apparatus according to claim 11, wherein
the presentation information includes a second feature amount having a larger contribution to prediction by the prediction model, in the data sample having the value of the first feature amount.

15. The information processing apparatus according to claim 11, wherein
the presentation information includes a first data sample and a second data sample included in a plurality of the data samples having the value of the first feature amount, the first and second data samples having a higher similarity in the feature amount and having positive and negative prediction errors.

16. The information processing apparatus according to claim 11, wherein
the presentation information includes an amount by which an average error in the data samples having the value of the first feature amount is larger than the average error in all the data samples.

17. The information processing apparatus according to claim 11, wherein
the presentation information includes a ratio of the data samples having the value of the first feature amount to all the data samples.

18. The information processing apparatus according to claim 11, wherein
the presentation information related to the first feature amount includes the feature amount for which a correlation value representing a correlation with the first feature amount is smaller.

19. An information processing method comprising:
calculating, by an information processing apparatus, an evaluation value for an evaluation data set used to evaluate a prediction model, for a predetermined number of data samples in a learning data set used for training of the prediction model; and
by the information processing apparatus, on a basis of the evaluation value for all the data samples in the learning data set and gradients of the data samples, generating presentation information for presenting advice related to at least one of the data samples in the learning data set or feature amounts of the data samples.

20. A program causing a computer to execute processing for:
calculating an evaluation value for an evaluation data set used to evaluate a prediction model, for a predetermined number of data samples in a learning data set used for training of the prediction model; and
on a basis of the evaluation value for all the data samples in the learning data set and gradients of the data samples, generating presentation information for presenting advice related to at least one of the data samples in the learning data set or feature amounts of the data samples.
